(19) United States
(12) Patent Application Publication
(10) Pub. No.: US 2025/0265682 A1
(43) Pub. Date: Aug. 21, 2025

(54) APPARATUS AND METHOD FOR PROCESSING IMAGE

(71) Applicant: SAMSUNG ELECTRONICS CO., LTD., Suwon-si (KR)

(72) Inventor: Sanghun KIM, Yongin-si (KR)

(73) Assignee: SAMSUNG ELECTRONICS CO., LTD., Suwon-si (KR)

(21) Appl. No.: 19/068,756

(22) Filed: Mar. 3, 2025

Related U.S. Application Data
(63) Continuation of application No. PCT/KR2025/002282, filed on Feb. 17, 2025.

(30) Foreign Application Priority Data
Feb. 21, 2024 (KR) 10-2024-0025332
Dec. 2, 2024 (KR) 10-2024-0176785

(51) Int. Cl. G06T 5/60; G06T 3/4046; G06T 5/50; G06T 7/20

(52) U.S. Cl. CPC G06T 5/60; G06T 3/4046; G06T 5/50; G06T 7/20; G06T 2207/10016; G06T 2207/20084; G06T 2207/30168

(57) ABSTRACT

An image processing apparatus includes at least one memory, a first processor, a second processor, and a video processor, wherein the first processor is configured to obtain an input image and information about the input image, determine a resource allocation amount of the second processor to execute at least one neural network executable by the second processor, control the second processor to generate a first quality-processed image through the at least one neural network, control the video processor to generate a second quality-processed image with respect to an image input to the video processor, and generate an output image through at least one of the first quality processing or the second quality processing.

### CROSS-REFERENCE TO RELATED APPLICATIONS

This application is a bypass continuation application of International Application No. PCT/KR2025/002282, filed on Feb. 17, 2025, which is based on and claims priority from Korean Patent Application No. 10-2024-0025332, filed on Feb. 21, 2024, and Korean Patent Application No. 10-2024-0176785, filed on Dec. 2, 2024, in the Korean Intellectual Property Office, the disclosures of which are herein incorporated by reference in their entireties.

### BACKGROUND

### 1. Field

One or more example embodiments of the disclosure relate to image processing, and more particularly, to an apparatus and method for processing an image to improve image quality.

### 2. Description of the Related Art

General image processing algorithms are implemented and executed in various types of hardware provided in image processing apparatuses. For example, an image processing algorithm may be implemented as an image processing circuit executable by a hardware device. Such image processing circuit has a logic suitable for each purpose and needs to be implemented individually. Accordingly, it may be hard for the image processing circuit to perform operations other than a particular operation for which the image processing circuit is specialized. In addition, it may be difficult to change an operation order among the image processing circuits once the operation order is set.

Recently, image processing algorithms using neural networks have been widely developed. By implementing algorithms used for image processing as neural network-based algorithms, the performance of each algorithm may be improved.

### SUMMARY

According to an aspect of an example embodiment of the disclosure, provided is an image processing apparatus including: at least one memory configured to store at least one instruction; a first processor configured to execute the at least one instruction stored in the at least one memory; a second processor; and a video processor, wherein the at least one instruction.

The at least one instruction, when executed by the first processor individually or collectively, causes the image processing apparatus to obtain an input image and information about the input image.

The at least one instruction, when executed by the first processor individually or collectively, causes the image processing apparatus to determine, based on the information about the input image, a resource allocation amount of the second processor to execute at least one neural network from among a plurality of neural networks executable by the second processor.

The at least one instruction, when executed by the first processor individually or collectively, causes the image processing apparatus to control the second processor to generate a first quality-processed image by performing first quality processing with respect to an image.

The at least one instruction, when executed by the first processor individually or collectively, causes the image processing apparatus to input to the second processor, through the at least one neural network based on the determined resource allocation amount.

The at least one instruction, when executed by the first processor individually or collectively, causes the image processing apparatus to control the video processor to generate a second quality-processed image by performing second quality processing which is hardware-based, with respect to an image input to the video processor.

The at least one instruction, when executed by the first processor individually or collectively, causes the image processing apparatus to generate an output image through at least one of the first quality processing or the second quality processing.

According to an aspect of an example embodiment of the disclosure, provided is an operating method of an image processing apparatus, the operating method including: obtaining an input image and information about the input image; determining, based on the information about the input image, a resource allocation amount of a second processor to execute at least one neural network from among a plurality of neural networks executable by the second processor; controlling the second processor to generate a first quality-processed image by performing first quality processing with respect to an image, input to the second processor, through the at least one neural network based on the determined resource allocation amount; controlling a video processor to generate a second quality-processed image by performing second quality processing which is hardware-based, with respect to an image input to the video processor; and generating an output image through at least one of the first quality processing or the second quality processing.

According to an aspect of an example embodiment of the disclosure, provided is non-transitory computer-readable recording medium having recorded thereon a program for performing a method including: obtaining an input image and information about the input image; determining, based on the information about the input image, a resource allocation amount of a second processor to execute at least one neural network from among a plurality of neural networks executable by the second processor; controlling the second processor to generate a first quality-processed image by performing first quality processing with respect to an image, input to the second processor, through the at least one neural network based on the determined resource allocation amount; controlling the video processor to generate a second quality-processed image by performing second quality processing which is hardware-based, with respect to an image input to the video processor; and generating an output image through at least one of the first quality processing or the second quality processing.

### BRIEF DESCRIPTION OF DRAWINGS

Example embodiments will be more clearly understood from the following detailed description taken in conjunction with the accompanying drawings.

FIG. 1 is a diagram illustrating image processing by an image processing apparatus according to an embodiment of the disclosure.

FIG. 2 is a block diagram illustrating a configuration of an image processing apparatus according to an embodiment of the disclosure.

FIG. 3 is a block diagram illustrating a configuration of an image processing unit according to an embodiment of the disclosure.

FIG. 4 is a flowchart illustrating an operation of an image processing apparatus according to an embodiment of the disclosure.

FIG. 5 is a flowchart illustrating an operation of determining a resource allocation amount with respect to a neural network model by an image processing apparatus according to an embodiment of the disclosure.

FIG. 6 illustrates an example of an image processing unit which is resource-allocated to a neural network model based on information about an input image according to an embodiment of the disclosure.

FIG. 7 illustrates an example of an image processing unit which is resource-allocated to a neural network model based on information about an input image according to an embodiment of the disclosure.

FIG. 8 illustrates an example of an image processing unit which is resource-allocated to a neural network model based on information about an input image according to an embodiment of the disclosure.

FIGS. 9A, 9B, 9C, and 9D are each a diagram illustrating an operation of performing image processing with respect to an input image by an image processing unit, according to an embodiment of the disclosure.

FIG. 10 is a flowchart illustrating an operation of determining, by an image processing apparatus according to an embodiment of the disclosure, a resource allocation amount with respect to a neural network based on characteristic information of an input image.

FIG. 11 illustrates an example of an image processing unit which is resource-allocated to a neural network based on a motion amount of an input image according to an embodiment of the disclosure.

FIG. 12 illustrates an example of an image processing unit which is resource-allocated to a neural network based on a motion amount of an input image according to an embodiment of the disclosure.

FIG. 13 illustrates an example of an image processing unit which is resource-allocated to a neural network based on quality of an input image according to an embodiment of the disclosure.

FIG. 14 illustrates an example of an image processing unit which is resource-allocated to a neural network based on quality of an input image according to an embodiment of the disclosure.

FIG. 15 is a flowchart illustrating an operation of performing image processing by an image processing apparatus according to an embodiment of the disclosure based on an activation/inactivation command.

FIG. 16 illustrates an example of an image processing unit which is resource-allocated to a neural network based on an inactivation command, according to an embodiment of the disclosure.

FIG. 17 illustrates an example of an image processing unit which is resource-allocated to a neural network based on an activation command regarding the low-power mode, according to an embodiment of the disclosure.

FIG. 18 is a detailed block diagram of an image processing apparatus according to an embodiment of the disclosure.

### DETAILED DESCRIPTION

As the disclosure allows for various changes and numerous embodiments, embodiments will be illustrated in the drawings and described in detail in the written description. However, this is not intended to limit embodiments to particular modes of practice, and it is to be appreciated that all changes, equivalents, and substitutes that do not depart from the spirit and technical scope of the disclosure are encompassed in embodiments.

In describing an embodiment of the disclosure, when a detailed explanation about related arts unnecessarily blur the gist of the disclosure, such explanation will be omitted. In addition, numbers used throughout the description (e.g., first, second, etc.) are only intended to distinguish one component from another.

Throughout the disclosure, the expression “at least one of a, b, or c” indicates only a, only b, only c, both a and b, both a and c, both b and c, all of a, b, and c, or variations thereof.

In addition, throughout the disclosure, when one component is “coupled to” or “connected to” another component, it should be construed as meaning that one component is directly connected to another component or one component is coupled or connected indirectly to another component via an intervening component arranged therebetween unless otherwise described.

As for components described as “ . . . unit,” “module,” etc., two or more components may be integrated with each other into a single component, or one component may be divided into two or more components according to subdivided functions. Also, each of the components to be described below may additionally perform all or a part of functions of other components, in addition to its main functions, and some of main functions of each components may be solely performed by other components.

Throughout the disclosure, the term “image” may refer to a still image, a frame, a motion clip including a plurality of consecutive still images, or a video.

In addition, the term “neural network” as used herein may be a representative example of an artificial neural network that imitates cranial nerves and is not limited to an artificial neural network using a particular algorithm. The neural network may refer to a deep neural network (DNN).

In addition, the term “first quality processing” as used herein may refer to artificial intelligence (AI) image quality processing. The term “first quality-processed image” may refer to an AI quality-processed image generated through the AI quality processing. Moreover, the term “second quality processing” as used herein may refer to quality processing performed based on a hardware through a video processor. The term “second quality-processed image” may refer to a quality-processed image generated through the video processor.

In the disclosure, functions relating to AI may be performed through a processor and a memory. The processor may include at least one processor. In this regard, the at least one processor may be a generic-purpose processor such as a central processing unit (CPU), an application processor (AP), a digital signal processor (DSP), etc., a graphic processor such as a graphic processing unit (GPU), a vision processing unit (VPU), etc., or a processor dedicated for artificial intelligence such as a neural processing unit (NPU). The at least one processor may control to process input data according to an artificial intelligence model or predefined operation rules stored in the memory. Or, when the at least one processor is a processor dedicated for artificial intelligence, the at least one processor may be designed to have a hardware structure specialized to process a particular artificial intelligence model.

In the disclosure, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner.

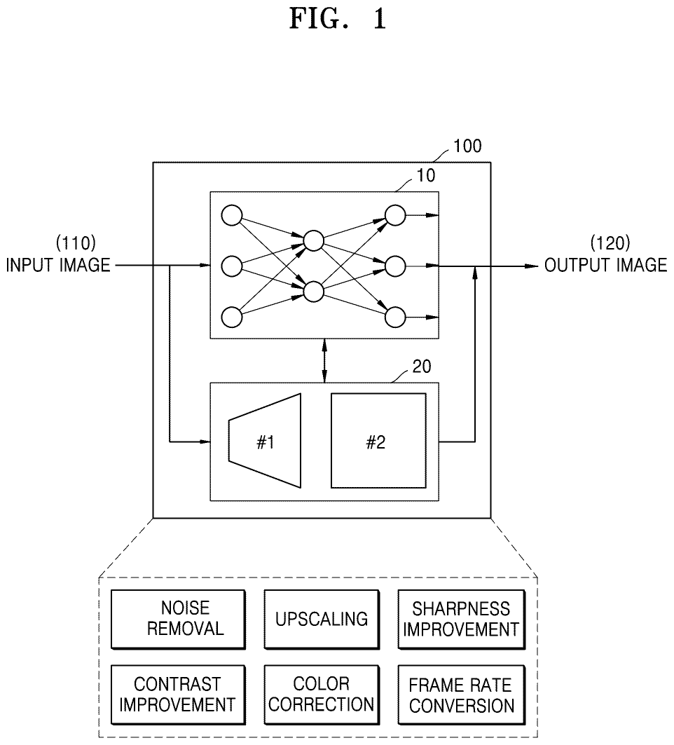

FIG. 1 is a diagram illustrating image processing by an image processing apparatus according to an embodiment of the disclosure.

Referring to FIG. 1, an image processing apparatus 100 according to an embodiment of the disclosure may be an electronic apparatus capable of processing and outputting an image. The image processing apparatus 100 may be implemented in various forms including a display. For example, the image processing apparatus 100 may be implemented as various electronic apparatuses such as a mobile phone, a table personal computer (PC), a digital camera, a camcorder, a laptop computer, a desktop computer, an electronic terminal, a digital broadcasting terminal, a personal digital assistant (PDA), a portable multimedia player (PMP), a navigation, an MP3 player, a wearable device, etc.

The image processing apparatus 100 according to an embodiment of the disclosure may generate an output image 120 by performing image processing with respect to an input image 110.

For example, the image processing apparatus 100 may generate the output image 120 by applying a noise removal algorithm, an upscaling algorithm, a sharpness enhancement algorithm, a contrast enhancement algorithm, a color correction algorithm, a frame rate up conversion (FRC) algorithm, etc. to the input image 110. However, the image processing performed by the image processing apparatus 100 is not limited thereto.

In an embodiment of the disclosure, an algorithm used for the image processing may be implemented as an algorithm based on an image processing circuit 20 or an algorithm based on an image processing neural network 10.

In an embodiment of the disclosure, the image processing circuit 20 may include various image processing circuits configured to perform operations corresponding to various image processing algorithms. Each image processing circuit may be specialized for single operation and may effectively process or accelerate target image processing. Various image processing circuits included in the image processing circuit 20 may include a hardware component, a circuit, and/or a logic required for each operation. For example, the image processing circuit 20 may be designed as a video processor specialized for image processing; however, the disclosure is not limited thereto.

When the image processing algorithm is implemented by the image processing circuit 20, the image processing may be accelerated, and precise operations may be enabled; however, as each image processing circuit has a logic suitable for each purpose, image processing circuits need to be implemented individually, and thus, the image processing circuits may not be capable of performing operations other than specialized operations. In addition, it may be difficult to change an operation order among the image processing circuits once the operation order is set.

When the image processing algorithm is implemented by the image processing neural network 10, the algorithm may learn and adapt to images having various properties and characteristics. Moreover, the image processing neural network 10 may be updated by training the network with new data, or a new quality processing algorithm may be applied thereto. The image processing neural network 10 may not be capable of performing precise operations and may take much time for operations, compared to the image processing circuit 20.

In an embodiment of the disclosure, the image processing apparatus 100 may include an image processing unit (not shown) in which an image processing algorithm is implemented by the image processing circuit 20 or the image processing neural network 10, by considering performance, function, purpose, necessity for precision control, suitability for AI operation (e.g., convolution operation), etc. of the image processing algorithm. A manufacturer of the image processing apparatus 100 may implement various image processing algorithms as one of the image processing circuit 20 and the image processing neural network 10 by considering one or more criterions described above.

For example, a quality processing algorithm for an 8 k resolution display may be implemented by only the image processing circuit 20 of the image processing apparatus 100. For example, the image processing circuit 20 may include first image processing circuits configured to process images having a resolution of 2 k or less, a first upscaler configured to upscale images having a resolution of 2 k or less to 4 k resolution images, second image processing circuits configured to process 4 k resolution images, a second upscaler configured to upscale 4 k resolution images to 8 k resolution images, and third image processing circuits configured to process 8 k resolution images.

In this case, when the resolution of an image input to the image processing apparatus 100 is 2 k or less, the image processing circuit 20 may process the image quality of the input image by using the first image processing circuits, upscale the resolution to 4 k by using the first upscaler, process the image quality of the image by using the second image processing circuits, upscale the resolution to 8 k by using the second upscaler, and process the image quality of the image by using the third image processing circuits to generate an output image.

On the other hand, when resolution of an image input to the image processing apparatus 100 is 4 k, as the first image processing circuits and the first upscaler included in the image processing circuit 20 are designed to be incapable of processing 4 k resolution images, the image processing circuit 20 may first apply the second image processing circuits to the input image.

As such, when some image processing circuits included in the image processing circuit 20 (e.g., the first image processing circuits, the first upscaler, etc.) are not used in quality processing of an input image depending on information (e.g., resolution information) about the input image input to the image processing apparatus 100, there may be a temporal redundancy issue. The temporal redundancy may refer to resource waste caused when the quality processing is performed while some resources are not used.

In addition, for example, when the FRC algorithm for a display supporting a frame rate (or a scan rate) of 120 Hz is implemented only by the image processing circuit 20 of the image processing apparatus 100, a time redundancy issue may be caused.

For example, when the input image has a low frame rate (e.g., 30 Hz or 60 Hz), the image processing circuit 20 may generate an image having a high frame rate (e.g., 120 Hz) by using the FRC circuit. The FRC algorithm may refer to a technology of improving a frame rate of a video image by predicting a new frame to be added between frames of the video image and compensating for the new frame.

On the other hand, when the image input to the image processing apparatus 100 has a high frame rate (e.g., 120 Hz), the designed FRC circuit is not used in the quality processing, and thus temporal redundancy may occur.

As such, when all image processing algorithms performed by the image processing apparatus 100 are implemented by the image processing circuit 20, image processing performance degradation may be caused due to the resource waste and temporal redundancy.

The image processing apparatus 100 according to an embodiment of the disclosure may implement a part of the image processing algorithm by the image processing neural network 10 and another part thereof by the image processing circuit 20.

In the image processing apparatus 100 an embodiment of the disclosure, an image processing algorithm which may or may not be used depending on properties and characteristics of the input image may be implemented by the image processing neural network 10, and an image processing algorithm which is more effective for image processing when using the image processing circuit 20 may be implemented by the image processing circuit 20. Accordingly, the image processing apparatus 100 may perform various image processing according to various properties and characteristics through the image processing neural network 10 and the image processing circuit 20, and minimize resource waste with respect to the image processing circuit 20 to improve image processing performance.

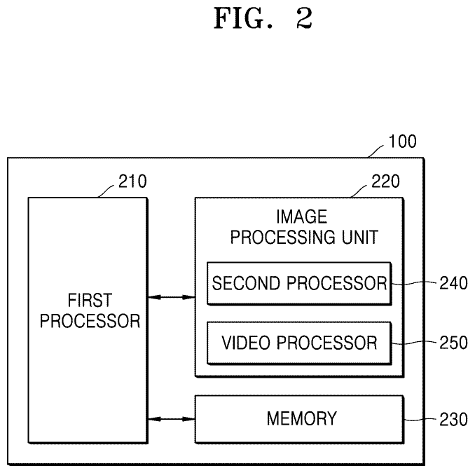

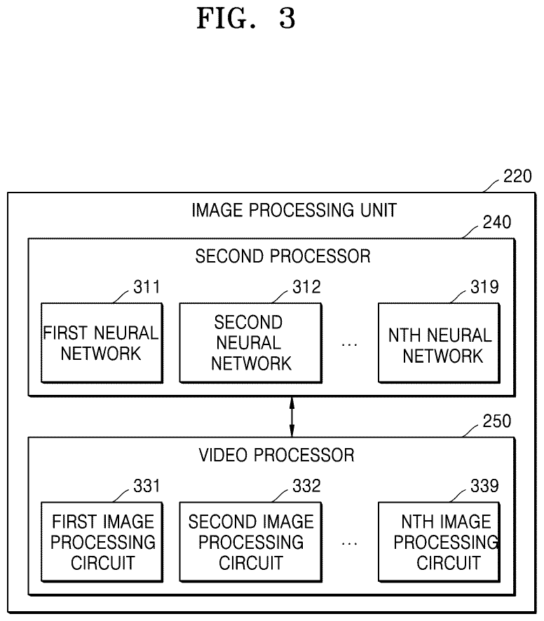

For example, an image processing algorithm which may or may not be used depending on properties and characteristics of the input image may include an image processing algorithm which may or may not be applied depending on the frame rate, size, etc. of the input image. The foregoing is to be described in detail in relation to FIGS. 2 and 3.

For example, an image processing algorithm which is more effective for image processing when using the image processing circuit 20 may include an upscaling algorithm for simply adjusting the size of image and/or an image processing algorithm in which a computation error needs to be minimized. The foregoing is to be described in detail in relation to FIGS. 2 and 3.

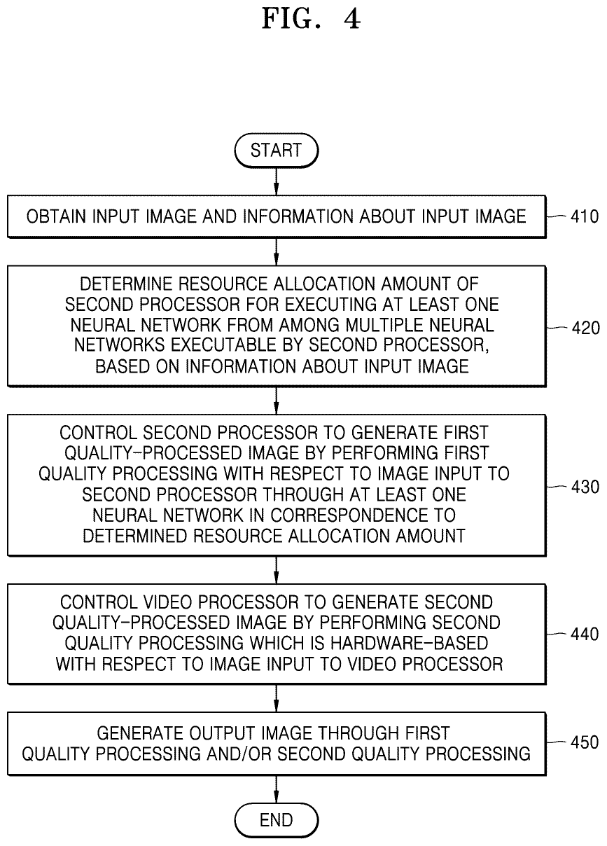

The image processing apparatus 100 according to an embodiment of the disclosure may flexibly adjust an allocation and an allocation amount of computation resources for performing the image processing neural network 10, based on the input image having various properties and characteristics. For example, the image processing apparatus 100 may determine, based on information about the input image, whether to allocate resources and the allocation amount with respect to the image processing neural network 10 configured to perform image processing regarding the information about the input image. For example, when there are two pieces of information about the input image, the image processing apparatus 100 may determine a resource allocation ratio with respect to two or more image processing neural networks 10 configured to perform image processing regarding each piece of information about the input image. Accordingly, as the image processing apparatus 100 performs the image processing by allocating limited computation resources to the image processing neural network 10 according to properties and characteristics of the input image, the quality processing performance of the image processing apparatus 100 may be maximized. The foregoing is to be described in detail in relation to FIGS. 4 to 14.

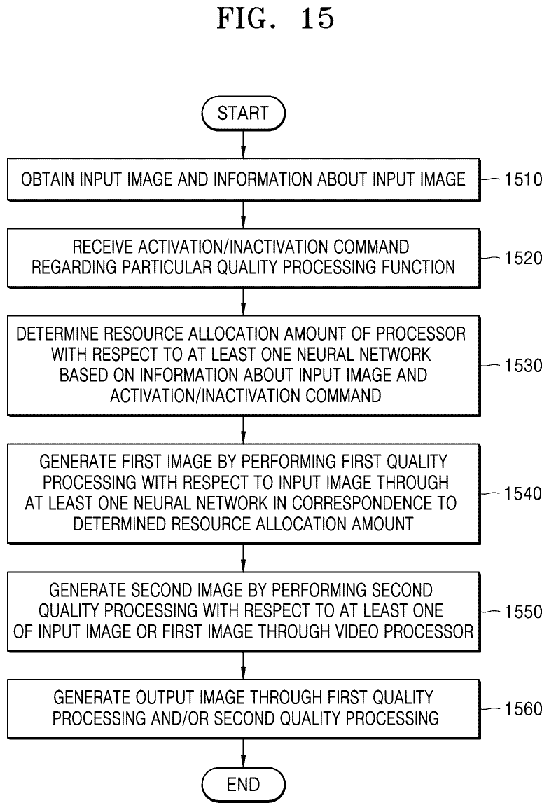

The image processing apparatus 100 according to an embodiment of the disclosure may change whether to allocate resources and the resource allocation amount with respect to the image processing neural network 10 according to a consumer, system requirements, etc., which is to be described in detail in relation to FIGS. 15 to 17.

Hereinafter, with reference to the drawings, the image processing apparatus 100 according to an embodiment of the disclosure in which an image processing algorithm is implemented by the image processing neural network 10 and/or the image processing circuit 20 is described according to an embodiment of the disclosure. In addition, a method of processing, by the image processing apparatus 100, an image by selectively using the image processing neural network 10 and/or the image processing circuit 20 according to an input image having various properties and characteristics is to be described.

FIG. 2 is a block diagram illustrating a configuration of an image processing apparatus according to an embodiment of the disclosure. FIG. 3 is a block diagram illustrating a configuration of an image processing unit according to an embodiment of the disclosure.

Referring to FIG. 2, the image processing apparatus 100 according to an embodiment of the disclosure may include a first processor 210, an image processing unit 220, and a memory 230.

The first processor 210 may control operations of the image processing apparatus 100. The first processor 210 according to an embodiment of the disclosure may execute at least one program stored in the memory 230. The first processor 210 according to an embodiment of the disclosure may include one or more processors.

The memory 230 according to an embodiment of the disclosure may store various data, a program, and/or an application for driving and controlling the image processing apparatus 100. The program stored in the memory 230 may include one or more instructions. The program (e.g., one or more instructions) and/or the application stored in the memory 230 may be executed by the first processor 210.

The memory 230 may be a component configured to store various programs or data and may include a storage medium such as read-only memory (ROM) random-access memory (RAM), hard disk, CD-ROM, or DVD or a combination thereof. The memory 230 may not be present separately and may be included in the first processor 210. The memory 230 may include a volatile memory, a non-volatile memory, or a combination thereof. The memory 230 may store programs and/or at least one instruction for executing operations according to an embodiment of the disclosure described below. The memory 230 may provide the stored data to the first processor 210 upon a request from the first processor 210.

At least one processor included in the first processor 210 according to an embodiment of the disclosure may be a general-purpose processor such as a central processing unit (CPU), an application processor (AP), a digital signal processor (DSP), etc., a graphic processor such as a graphic processing unit (GPU), a vision processing unit (VPU), etc., or an artificial intelligence processor such as a neural processing unit (NPU). Or, according to an embodiment of the disclosure, the first processor 210 may be a circuitry implemented in the form of a system-on-chip (SoC) or an integrated circuit (IC) in which at least one of CPU, GPU, VPU, or NPU is integrated therein.

The image processing unit 220 according to an embodiment of the disclosure may perform image processing with respect to video data. The input image may be transmitted to the image processing unit 220 according to the control by the first processor 210. The image processing unit 220 may decode an input image signal and perform scaling on the decoded image signal to adjust the size of the decoded image signal to fit a frame to be output on a display. The image processing unit 220 may apply various image processing algorithms with respect to the image to generate an image-processed output image.

The image processing unit 220 according to an embodiment of the disclosure may include a second processor 240 and a video processor 250.

The second processor 240 may include one or more processors configured to run the image processing neural network (for example, 10 of FIG. 1). The second processor 240 may be manufactured in the form of a hardware chip dedicated for artificial intelligence (for example, NPU). Or, the second processor 240 may be implemented as a part of an existing general-purpose processor (e.g., CPU or AP) or a graphic processor (e.g., GPU).

The video processor 250 may be a processor configured to execute the image processing circuit (for example, 20 of FIG. 1). The video processor 250 may be a processor specialized for image processing and may include a hardware component, a circuit, a logic, etc. related to image processing. For example, the video processor 250 may include at least one of an application specific integrated circuit (ASIC) or a field programmable gate array (FPGA); however, the disclosure is not limited thereto.

The second processor 240 and the video processor 250 may receive and send video data corresponding to the image by using a frame memory or a line buffer. The frame memory may store at least one frame. The line buffer may store lines constituting a frame in real time.

Referring to FIG. 3, the second processor 240 according to an embodiment of the disclosure may execute a plurality of neural networks according to the control by the first processor 210. For example, the plurality of networks may include first to nth neural networks 311 to 319. The second processor 240 may perform various image processing algorithms by using the first to nth neural networks 311 to 319.

For example, the plurality of neural networks may include an upscaling model (or a super-resolution model) capable of converting a low-resolution image into a high-resolution image. The upscaling model may learn a difference between the low-resolution image and the high-resolution image and obtain a sharper and more precise high-resolution image from the low-resolution image. For example, the upscaling model may include various neural networks according to an input resolution and an output resolution, such as a 2 k-to-4 k upscaling model, a 4 k-to-8 k upscaling model, a 4 k-to-4 k upscaling model, an 8 k-to-8 k upscaling model, etc.

For example, the resolution may include standard definition (SD), high definition (HD), full high definition (FHD), quad high definition (QHD), 4K ultra high definition (UHD), 8K UHD, or higher.

In this regard, the 2 k-to-4 k upscaling model may be a neural network configured to execute a 2 k-to-4 k upscaling algorithm for generating a 4 k output image from an input image having a resolution of 2 k or less.

In this regard, the 4 k-to-4 k upscaling model may be a neural network to improve the quality of image by generating a texture for a 4 k image or enhancing the sharpness, instead of adjusting the size of the image.

For example, the plurality of neural networks may include a neural network capable of implementing an FRC algorithm. For example, the plurality of neural networks may include an FRC model, a motion estimation model, a motion compensation model, etc. For example, the motion estimation model may be a neural network configured to estimate a motion between the frames of the image and extract the motion in the form of motion vector. For example, the motion compensation model may be a neural network configured to compensate for a new frame by using the extracted motion vector and obtains a high-frame rate image from a low-frame rate image.

For example, the plurality of neural networks may include a contrast enhancement (or contrast improvement) model. The image processing unit 220 may infer a pixel-to-pixel mapping function (or mapping curve) by analyzing the image through the contrast enhancement model and apply the inferred mapping function to the image to implement a contrast enhancement (or contrast enhancement) algorithm which obtains a stereoscopic image.

For example, the plurality of neural networks may include an image quality analysis model configured to analyze the image quality or the quality of the input image. For example, the image processing unit 220 may obtain characteristic information of an image through the image quality analysis model, such as compression deterioration degree, blurriness degree, deterioration degree, sharpness, noise level, resolution, etc. of the image.

For example, the plurality of neural networks may include a classification model configured to identify a genre under which the input image falls. For example, the image processing unit 220 may identify and classify the genre of the input image by using the classification model, for example, movie, documentary, news, sports, animation, etc.

The video processor 250 according to an embodiment of the disclosure may include a plurality of image processing circuits. The plurality of image processing circuits may include first to nth image processing circuits 331 to 339. The video processor 250 may perform various image processing algorithms by using the first to nth image processing circuits 331 to 339. The video processor 250 may perform image processing by the control by the first processor 210.

For example, the plurality of image processing circuits may include an upscaler. The upscaler may include a circuit configured to perform an upscaling algorithm. The upscaler may include one or more upscalers supporting processing of images having different resolutions from each other. For example, the upscaler may include at least one of the first upscaler configured to implement the 2 k-to-4 k upscaling algorithm or the second upscaler configured to implement the 4 k-to-8 k upscaling algorithm.

For example, the plurality of image processing circuits may include a color correction circuit. The color correction circuit may correspond to an image processing circuit configured to perform a dispersion calibration algorithm (for example, color, brightness, color temperature correction), a tone mapping algorithm, a high dynamic range (HDR) image processing algorithm, etc.

In the image processing apparatus 100 according to an embodiment of the disclosure, the image processing algorithm may be implemented as an image processing neural network executed in the second processor 240 or an image processing circuit executed in the video processor 250, according to the performance, function, purpose, need for precise control, suitability for AI computation (for example, convolution computation) of the image processing algorithm.

In the image processing apparatus 100 according to an embodiment of the disclosure, the image processing algorithm may be implemented as an image processing circuit or an image processing neural network according to a purpose of the image processing algorithm.

For example, the upscaling algorithm may be implemented as an upscaler to be used for simply adjusting the size of the image. Or, for example, the upscaling algorithm may be used for performing upscaling on input images having various properties and characteristics or may be implemented as an upscaling model when used for generating textures or processing sharpness enhancement, etc., in addition to the adjustment of the size of the image.

In the image processing apparatus 100 according to an embodiment of the disclosure, when minimization of computation error of an image processing algorithm is needed, the image processing algorithm may be implemented as an image processing circuit.

For example, for the image color improvement algorithm, the display dispersion calibration algorithm, the tone mapping algorithm, and the HDR image processing algorithm, the intrinsic deviation of the display may need to be adjusted precisely to be less than or equal to a certain error. Accordingly, the aforementioned algorithms may be implemented as an image processing circuit (for example, a color correction circuit) instead of an image processing neural network. However, the disclosure is not limited thereto, and some of the aforementioned algorithms may be implemented as an image processing neural network in consideration of the performance of the image processing apparatus 100.

In the image processing apparatus 100 according to an embodiment of the disclosure, when the image processing algorithm is suitable for AI computation, the image processing algorithm may be implemented as an image processing neural network.

For example, in comparison with the existing image processing algorithms that each need an inherent logic, generally, the AI-based image processing technology uses the same computation for different purposes. For example, the upscaling algorithm and the noise removal algorithm may be executed in the second processor 240 through the same computation, for example, convolution computation even when the algorithms have different purposes. As such, according to whether the image processing algorithms are executable by the same processor, the image processing algorithms may be implemented in the second processor 240.

The image processing apparatus 100 comprising the image processing unit 220 according to one or more of the aforementioned criterions may allocate resources of the second processor 240 for performing the neural network according to information of the input image, characteristics information of the input image, a consumer, or system requirements, and control at least one of the second processor 240 or the video processor 250 to generate an image quality-processed output image.

The first processor 210 according to an embodiment of the disclosure may obtain an input image and information about the input image.

The first processor 210 according to an embodiment of the disclosure may determine the resource allocation amount of the second processor 240 for performing at least one neural network from among the plurality of neural networks executable by the second processor 240, based on the information about the input image. The first processor 210 according to an embodiment of the disclosure may determine the resource allocation amount of the second processor 240 for performing at least one neural network, based on at least one of information of input image, characteristics information, or activation command.

The first processor 210 according to an embodiment of the disclosure may control the second processor 240 to generate a first quality-processed image by performing first quality processing with respect to an image, input to the second processor 240, through at least one neural network based on the determined resource allocation amount. The first quality processing may correspond to AI quality processing. The first quality-processed image may correspond to an AI quality-processed image generated through the AI quality processing.

For example, the first processor 210 may control the second processor 240 to generate an image upscaled through the upscaling model.

For example, the first processor 210 may control the second processor 240 to generate an image with improved frame rate through a neural network capable of implementing an FRC algorithm.

The first processor 210 according to an embodiment of the disclosure may control the video processor 250 to generate a second quality-processed image by performing second quality processing with respect to an image input to the video processor 250 through at least one image processing circuit. The second quality processing may correspond to hardware-based quality processing performed through a quality processing circuit implemented in the video processor 250. The second quality-processed image may correspond to a quality-processed image generated through hardware-based quality processing.

For example, the first processor 210 may control the video processor 250 to generate an image upscaled through the upscaler.

For example, the first processor 210 may control the video processor 250 to generate an image on which color correction is performed through the color correction circuit.

The image processing apparatus 100 according to an embodiment of the disclosure may improve the quality processing performance by adaptively changing whether to allocate computation resources to the neural network and the computation resource allocation amount according to information about the input image, characteristics information of the input image, a consumer, system requirements, etc.

FIG. 4 is a flowchart illustrating an operation of an image processing apparatus according to an embodiment of the disclosure.

Referring to FIG. 4, in operation 410, the image processing apparatus 100 according to an embodiment of the disclosure may obtain the input image and information about the input image.

The image processing apparatus 100 may receive the input image through an external device connected wired or wirelessly thereto. For example, the image processing apparatus 100 may be connected to an external device and receive various images through an input/output interface such as HDMI. Or, for example, the image processing apparatus 100 may be connected to an external device and receive an image through a communication module such as Wi-Fi, WLAN, etc.

The image processing apparatus 100 may obtain information about the input image through meta data of the input image. For example, the information about the input image may include bit rate information (e.g., 40 Mbps), codec information (e.g., H.254, HEVC), resolution information (e.g., 4 k, 8 k), frame rate information (e.g., 60 Hz, 120 Hz), etc. of the input image. The frame rate may be referred to as a frame per second or a scan rate.

In operation 420, the image processing apparatus 100 according to an embodiment of the disclosure may determine a resource allocation amount of the second processor 240 for executing at least one neural network from among the plurality of neural networks executable by the second processor 240, based on the information about the input image.

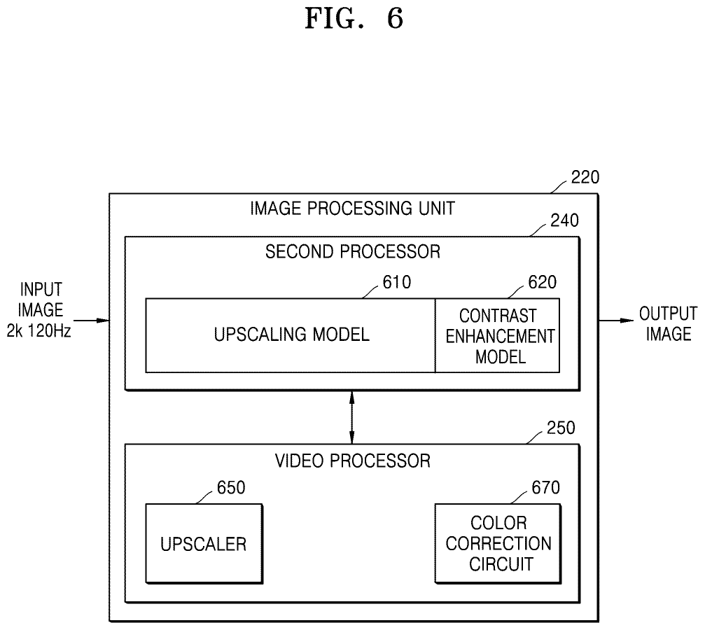

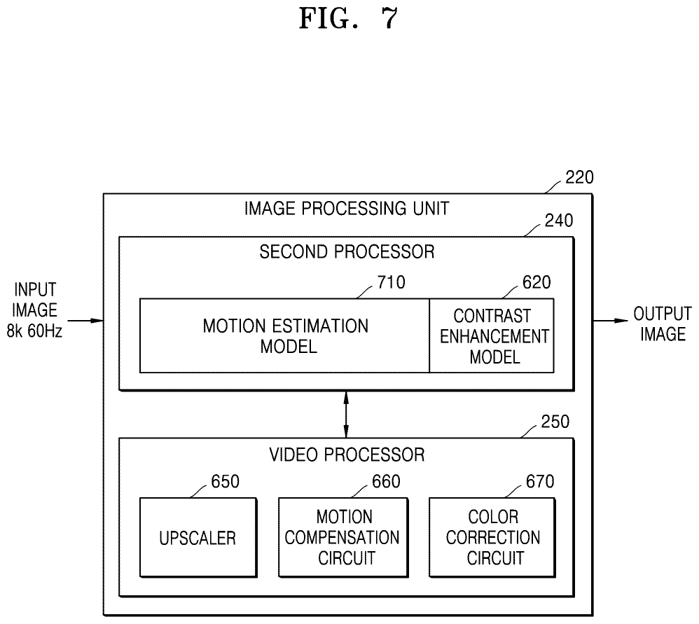

For example, in the image processing apparatus 100, the upscaling algorithm, the color correction algorithm, etc. may be implemented as a hardware circuit executed in the video processor 250. For example, the image processing apparatus 100 may include an upscaler (e.g., 650 in FIG. 6) in which an upscaling algorithm is implemented, a color correction circuit (e.g., 670 in FIG. 6) in which a color correction algorithm is implemented, etc. The image processing apparatus 100 may further include a motion compensation circuit (e.g., 660 in FIG. 7) in which a frame rate conversion algorithm is implemented.

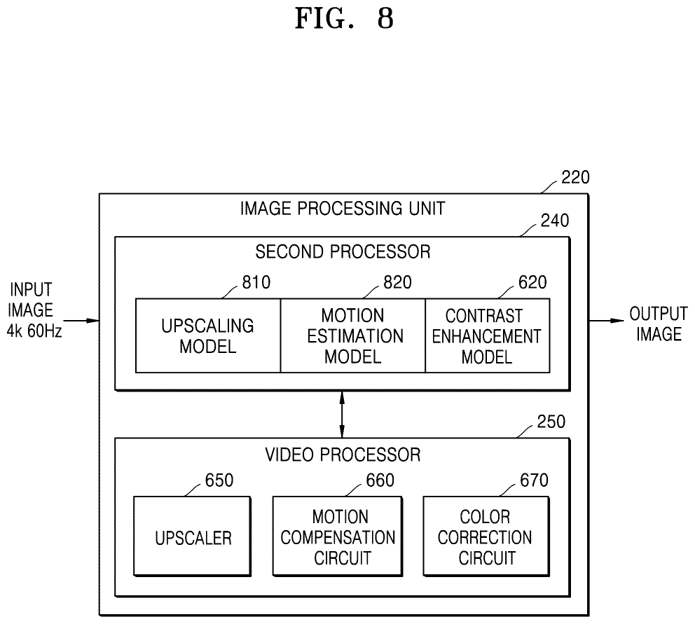

For example, in the image processing apparatus 100, the upscaling algorithm, the frame rate conversion algorithm, the contrast enhancement algorithm, etc. may be implemented as a neural network executed in the second processor 240. For example, the image processing apparatus 100 may include an upscaling model (e.g., 610 in FIG. 6, 810 in FIG. 8) in which an upscaling algorithm is implemented and a contrast improved model (e.g., 620 in FIG. 6) in which a contrast enhancement algorithm is implemented. The image processing apparatus 100 may further include a model in which a frame rate conversion algorithm is implemented, for example, a motion estimation model (e.g., 710 in FIGS. 7 and 820 in FIG. 8), a motion compensation model, or an FRC model.

The image processing apparatus 100 according to an embodiment of the disclosure may perform resource distribution with respect to various neural networks executed in the second processor 240 to have optimized quality processing performance with respect to the input image having various information. The first processor 210 may control the second processor 240 to perform optimized resource distribution with respect to the neural network, in various image scenarios (e.g., various properties and characteristics of the input image).

The image processing apparatus 100 according to an embodiment of the disclosure may determine whether to allocate resources and the resource allocation amount with respect to the neural network, based on the information about the input image. When the input image is received, the image processing apparatus 100 may allocate resources to a neural network relating to the input image in real time. In this regard, the real time resource allocation may include not only the resource allocation that takes place simultaneously with the reception of the input image but also resource allocation that is conducted after the reception of the input image in certain time.

The image processing apparatus 100 according to an embodiment of the disclosure may determine whether to allocate resources to each of two or more neural networks, based on two or more input image information. For example, the image processing apparatus 100 may determine a ratio regarding the resource allocation amount of the second processor 240 with respect to two or more neural networks, based on values representing two or more input image information, respectively.

For example, the image processing apparatus 100 may determine, based on first information of the input image, the resource allocation amount of the second processor 240 with respect to the first neural network configured to perform image processing regarding the first information, from among the plurality of neural networks. The first information may be resolution information such as 2 k, 4 k, 8 k, etc., and the first neural network may be an upscaling model.

For example, the image processing apparatus 100 may determine, based on second information of the input image, the resource allocation amount of the second processor 240 with respect to the second neural network configured to perform image processing regarding the second information, from among the plurality of neural networks. The second information may be frame rate information such as 60 Hz, 120 Hz, etc., and the second neural network may be a motion estimation model.

For example, the image processing apparatus 100 may determine the resource allocation amount with respect to the first neural network and the resource allocation amount with respect to the second neural network according to a value representing the first information of the input image (e.g., resolution) and a value representing the second information of the input image (e.g., frame rate).

For example, when the input image has a low resolution, the image processing apparatus 100 may increase the resource allocation ratio with respect to the first neural network. For example, when the input image has a low frame rate, the image processing apparatus 100 may increase the resource allocation ratio with respect to the second neural network.

For example, when the input image has a high resolution, the image processing apparatus 100 may not allocate resources with respect to the first neural network. For example, when the input image has a high frame rate, the image processing apparatus 100 may not allocate resources with respect to the second neural network.

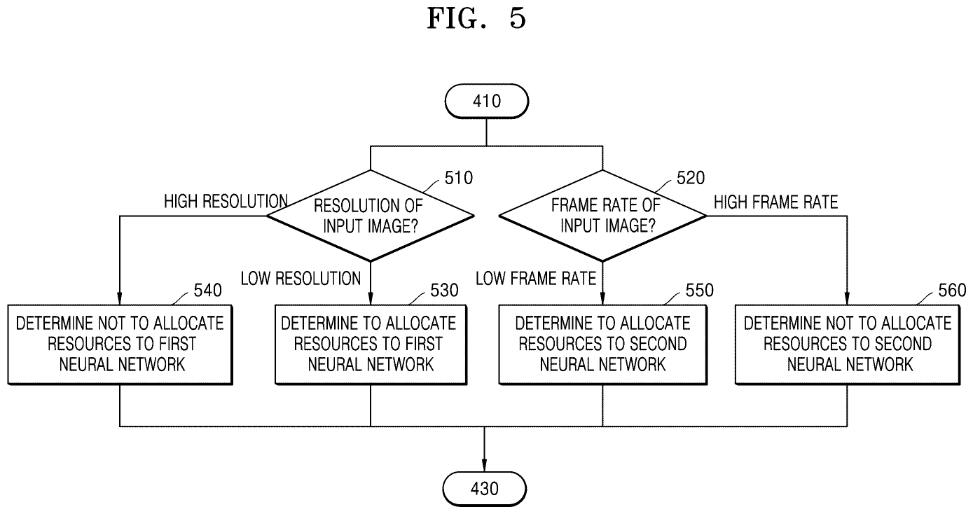

The foregoing is to be described in detail in relation to FIG. 5.

In operation 430, the image processing apparatus 100 according to an embodiment of the disclosure may generate the first quality-processed image by performing the first quality processing with respect to the image, input to the second processor 240, through at least one neural network based on the determined resource allocation amount. For example, the first processor 210 may control the second processor 240 to generate the first quality-processed image.

The first quality processing may correspond to AI quality processing. The first quality-processed image may correspond to an AI quality-processed image generated through the AI quality processing.

For example, the image input to the second processor 240 may be an input image (or original image) received by the image processing apparatus 100 or an image which is second image quality-processed through the video processor 250. The image input to the second processor 240 may change according to an order of the first quality processing and the second quality processing. For example, when the first quality processing is first performed before the second quality processing, the image input to the second processor 240 may be the original image received by the image processing apparatus 100. In another example, when the second quality processing is first performed before the first quality processing, the image input to the second processor 240 may be the image which is second image quality-processed through the video processor 250.

According to the allocation of resources of the second processor 240 to at least one neural network, the image processing apparatus 100 may perform the first quality processing with respect to the image, input to the second processor 240, through the at least neural network. The image processing apparatus 100 may generate an AI quality-processed image by performing the AI quality processing with respect to an image through at least one neural network.

For example, when the input image has a low resolution, the image processing apparatus 100 may generate an image with improved resolution by performing the upscaling with respect to the input image through the first neural network.

For example, when the input image has a low frame rate, the image processing apparatus 100 may obtain motion vector information of the input image through the second neural network. Based on the motion vector information and the input image, the image processing apparatus 100 may perform the motion compensation processing by using the motion compensation circuit in the video processor 250 to be described to generate an image with improved frame rate.

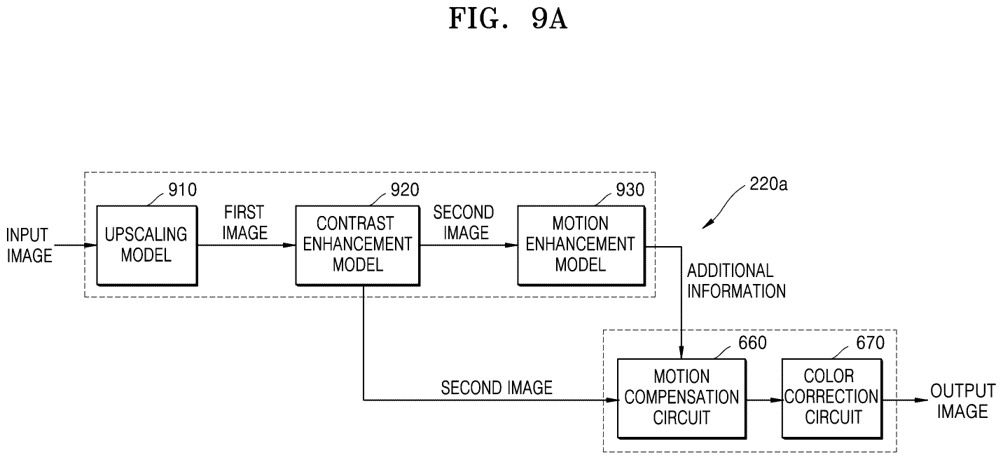

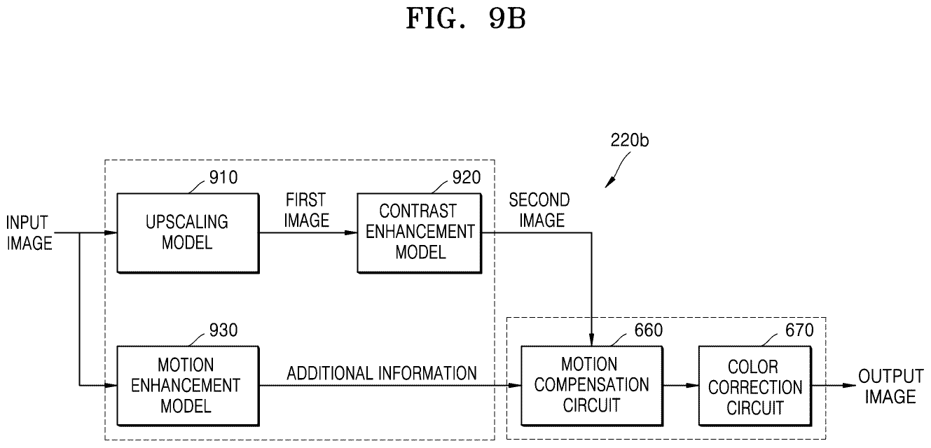

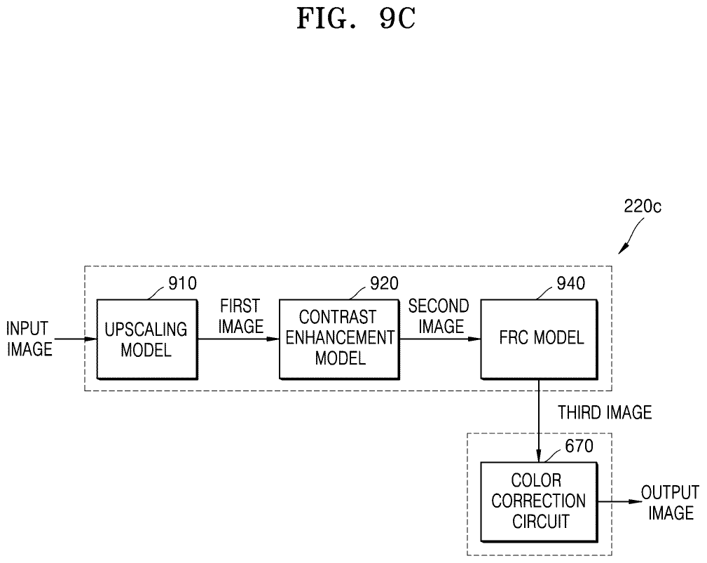

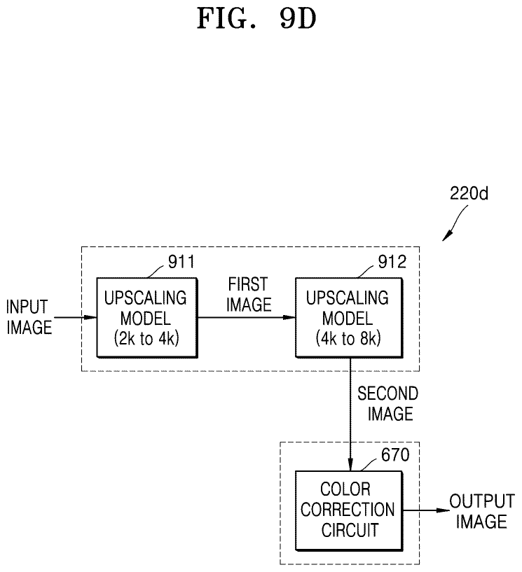

According to the allocation of resources of the second processor 240 to the plurality of neural networks, the image processing apparatus 100 may execute the plurality of neural networks sequentially or in parallel to generate the AI quality-processed image (see e.g., FIGS. 9A, 9B, 9C, and 9D).

In operation 440, the image processing apparatus 100 according to an embodiment of the disclosure may perform the second image quality-performing in which an image input to the video processor 250 is image-quality processed based on a hardware to generate a second quality-processed image. For example, the first processor 210 may control the video processor 250 to generate the second quality-processed image.

The second quality processing may correspond to hardware-based quality processing performed through a quality processing circuit implemented in the video processor 250. The second quality-processed image may correspond to a quality-processed image generated through hardware-based quality processing.

For example, the image input to the video processor 250 may be an input image (or original image) received by the image processing apparatus 100 or an image which is first image quality-processed through the second processor 240. The image input to the video processor 250 may change according to an order of the first quality processing and the second quality processing. For example, when the first quality processing is first performed before the second quality processing, the image input to the video processor 250 may be the image which is first image quality-processed through the second processor 240. In another example, when the second quality processing is first performed before the first quality processing, the image input to the video processor 250 may be the original image received by the image processing apparatus 100.

For example, when the input image has a low resolution and the resources of the second processor 240 are not allocated to the first neural network, the image processing apparatus 100 may perform the upscaling with respect to the input image through the upscaler to generate an image with improved resolution.

For example, the image processing apparatus 100 may perform the motion compensation processing based on the input image and the motion vector information obtained from the second neural network to generate an image with improved frame rate.

In operation 450, the image processing apparatus 100 according to an embodiment of the disclosure may generate an output image through the first quality processing and/or the second quality processing.

The image processing apparatus 100 may perform only the first quality processing, perform only the second quality processing, or perform both the first quality processing and the second quality processing to generate a quality-processed image.

The image processing apparatus 100 may change a neural network to which the computation resources are to be allocated based on the information about the input image and perform the first quality processing by using various neural networks to effectively generate the first quality-processed image.

For example, as quality processing for each image may be performed by using the limited computation resources of the second processor 240, the quality processing performance of the image processing apparatus 100 may be maximized. For example, the image processing apparatus 100 may increase the execution time of the upscaling model in relation to an image having a low resolution and a high frame rate to generate an image which is sharper and more detailed and has a high resolution. For example, the image processing apparatus 100 may increase the execution time of the motion estimation model in relation to an image having a high resolution and a low frame rate to improve the accuracy of the motion amount estimation.

In addition, the image processing apparatus 100 may implement the image processing algorithm by the neural network instead of the image processing circuit to minimize the temporal redundancy caused as the image processing circuit predesigned in the image processing apparatus 100 is not used.

In addition, in the image processing apparatus 100, as the an image processing algorithm that requires minimized computation error may use the image processing circuit for precise second quality processing, the quality processing performance may be improved.

FIG. 5 is a flowchart illustrating an operation of determining a resource allocation amount with respect to a neural network by an image processing apparatus according to an embodiment of the disclosure.

In FIG. 5, the first information may be resolution information, and the second information may be frame rate information.

In operation 510, the image processing apparatus 100 according to an embodiment of the disclosure may determine the resource allocation amount with respect to the first neural network based on the first information, e.g., resolution information of the input image.

In operation 520, the image processing apparatus 100 according to an embodiment of the disclosure may determine the resource allocation amount of the second processor 240 with respect to the second neural network based on the second information, e.g., frame rate information of the input image.

For example, when the input image has a low resolution, the image processing apparatus 100 may determine to allocate resources to the first neural network (operation 530). For example, when the input image has a high resolution, the image processing apparatus 100 may determine not to allocate resources to the first neural network (operation 540). For example, the low resolution may refer to 2 k or 4 k resolution, and the high resolution may refer to 8 k resolution.

For example, when the resolution of the input image is 2 k, the first neural network to which resources of the second processor 240 are allocated may include an upscaling model capable of performing quality processing of a resolution of 2 k or higher, for example, a 2 k-to-4 k upscaling model, a 4 k-to-8 k upscaling model, etc. For example, when the resolution of the input image is 4 k, the first neural network to which resources of the second processor 240 are allocated may include an upscaling model capable of performing quality processing of a resolution of 4 k or higher, for example, a 4 k-to-8 k upscaling model, etc.

For example, when the input image has a low frame rate, the image processing apparatus 100 may determine to allocate resources to the second neural network (operation 550). For example, when the input image has a high frame rate, the image processing apparatus 100 may determine not to allocate resources to the second neural network (operation 560). For example, the low frame rate may refer to 30 Hz, 60 Hz, etc., and the high frame rate may refer to 120 Hz.

The resource allocation may refer to allocation of processor resources by selecting one of processes in ready state to memory. For example, the resource allocation amount may refer to time allocated for performing, by the second processor 240, computation with respect to a selected process, e.g., resource allocation time.

In an embodiment of the disclosure, when two or more information about the input image is obtained, the image processing apparatus 100 may determine a ratio of the resource allocation amount with respect to two or more neural networks based on values representing respective information.

For example, when the input image has a low resolution and a high frame rate, the image processing apparatus 100 may determine the resource allocation amount with respect to the first neural network to be greater than the resource allocation amount with respect to the second neural network (see FIG. 6).

For example, when the input image has a high resolution and a low frame rate, the image processing apparatus 100 may determine the resource allocation amount with respect to the first neural network to be less than the resource allocation amount with respect to the second neural network (see FIG. 7).

For example, when the input image has a low resolution and a low frame rate, the image processing apparatus 100 may determine the resource allocation amount with respect to the first neural network to correspond to the resource allocation amount with respect to the second neural network. In this case, the resource allocation amount with respect to the first neural network and the resource allocation amount with respect to the second neural network may be identical (or similar) to each other. For example, a ratio between the resource allocation amount with respect to the first neural network and the resource allocation amount with respect to the second neural network may be 1:1 (or similar to 1:1) (see FIG. 8).

For example, when the input image has a high resolution and a high frame rate, the image processing apparatus 100 may allocate resources to a neural network other than the first neural network and the second neural network. For example, when the input image has a high resolution and a high frame rate, as there is no need to use the first neural network and the second neural network, the image processing apparatus 100 may not allocate the resources of the second processor 240 to the first neural network and the second neural network.

FIG. 6 illustrates an example of an image processing unit which is resource-allocated to a neural network based on information about an input image according to an embodiment of the disclosure.

FIG. 6 illustrates neural networks to which resources of the second processor 240 are allocated when the resolution information of an image input to the image processing apparatus 100 is 2 k, and frame rate information is 120 Hz. In FIG. 6, an area of each neural network block corresponds to an allocation amount of resources of the second processor 240.

In an embodiment of the disclosure, the first processor 210 may allocate the resources of the second processor 240 to an upscaling model 610 based on the resolution information of the input image. The first processor 210 may control the second processor 240 to perform the upscaling through the upscaling model 610 to which the resources are allocated. In some cases, the first processor 210 may control the video processor 250 to perform the upscaling through an upscaler 650 which is implemented in the video processor 250.

The upscaling model 610 may include an upscaling model having various input resolutions and output resolutions.

In an embodiment of the disclosure, the first processor 210 may allocate the resources of the second processor 240 to the upscaling model 610 having various input resolutions and output resolutions according to a resolution and a target resolution of the input image.

For example, when the resolution of the input image is 2 k, the first processor 210 may allocate the resources of the second processor 240 to an upscaling model capable of processing image quality of 2 k or higher. For example, the first processor 210 may allocate the resources of the second processor 240 to the 2 k-to-4 k upscaling model and the 4 k-to-8 k upscaling model. In this case, the image processing unit 220 may operate as illustrated in FIG. 9D.

Or, in an embodiment of the disclosure, the first processor 210 may allocate the resources of the second processor 240 to various types of upscaling models 610 by considering the types of upscaling model 610 included in the video processor 250.

For example, when the upscaler 650 implemented in the video processor 250 includes a first upscaler implementing the 2 k-to-4 k upscaling algorithm, the first processor 210 may not allocate the resources of the second processor 240 to the 2 k-to-4 k upscaling model and allocate the resources only to the 4 k-to-8 k upscaling model. Or, for example, when the upscaler 650 implemented in the video processor 250 includes a second upscaler implementing the 2 k-to-8 k upscaling algorithm, the first processor 210 may allocate the resources only to the 2 k-to-4 k upscaling model.

Or, in an embodiment of the disclosure, the first processor 210 may allocate the resources of the second processor 240 to various types of upscaling models 610 by further considering remaining computation amounts of the second processor 240.

For example, when the second processor 240 has a small remaining computation amount, the first processor 210 may not allocate the resources of the second processor 240 to the upscaling model 610. In this case, the image processing unit 220 may perform upscaling with respect to the input image by using the upscaler 650. Or, for example, when the second processor 240 has a great remaining computation amount, the first processor 210 may allocate the resources of the second processor 240 to the upscaling model 610.

The image processing unit 220 may generate a 4 k resolution image through any one of the first upscaler and the 2 k-to-4 k upscaling model and generate an 8 k resolution image through any one of the second upscaler and the 4 k-to-8 k upscaling model.

For example, the image processing unit 220 may generate an 8 k resolution image through the 2 k-to-4 k upscaling model and the 4 k-to-8 k upscaling model.

Or, for example, the image processing unit 220 may generate a 4 k resolution image from the input image through the first upscaler and generate an 8 k resolution image from the 4 k resolution image through the 4 k-to-8 k upscaling model to generate a high-quality image including a high-quality component of 8 k pixel units.

Or, for example, the image processing unit 220 may generate a 4 k resolution image through the 2 k-to-4 k upscaling model and generate an 8 k resolution image through the second upscaler to reduce the computation amount. The image processing apparatus 100 may determine whether to allocate resources to a neural network according to a purpose of upscaling, such as performance enhancement, computation amount reduction, etc.

The first processor 210 may not allocate resources of the second processor 240 to a model implementing an FRC algorithm when the frame rate is 120 Hz. The first processor 210 may further allocate the resources of the second processor 240 to a contrast enhancement model 620 to perform a contrast enhancement algorithm with respect to the input image. In this regard, the resources amount allocated to the upscaling model 610 may be greater than the resource amount allocated to the contrast enhancement model 620; however, the disclosure is not limited thereto.

The image processing unit 220 may perform color compensation with respect to an image input to the video processor 250 through a color correction circuit 670 to generate a color-corrected image.

The image processing unit 220 may generate an output image by using at least one of the second processor 240 or the video processor 250. For example, the output image may be an image which is upscaled, contrast-improved, and color-corrected from an input image.

The image processing apparatus 100 according to an embodiment of the disclosure may increase the execution time of the upscaling model in relation to an image having a low resolution and a high frame rate to generate an image which is sharper and more detailed and has a high resolution.

FIG. 7 illustrates an example of an image processing unit which is resource-allocated to a neural network based on information about an input image according to an embodiment of the disclosure.

FIG. 7 illustrates neural networks to which resources of the second processor 240 are allocated when the resolution information of an image input to the image processing apparatus 100 is 8 k, and frame rate information is 60 Hz. In FIG. 7, an area of each neural network block corresponds to an allocation amount of resources of the second processor 240.

For example, the first processor 210 may allocate the resources of the second processor 240 to a model implementing an FRC algorithm when the frame rate of the input is 60 Hz. For example, the model implementing the FRC algorithm may include a motion estimation model 710. FIG. 7 illustrates a case where a motion compensation circuit 660 is implemented in the video processor 250, and accordingly, the resources of the second processor 240 may not be allocated to the motion compensation model or the FRC model. However, the disclosure is not limited thereto, and when the motion compensation circuit 660 is not omitted, the resources of the second processor 240 may be allocated to the motion compensation model or the FRC model.

The first processor 210 may not allocate the resources of the second processor 240 to the upscaling model when the resolution is 8 k. The first processor 210 may further allocate the resources of the second processor 240 to a contrast enhancement model 620 to perform a contrast enhancement algorithm with respect to the input image. In this regard, the resources amount allocated to the motion estimation model 710 may be greater than the resource amount allocated to the contrast enhancement model 620; however, the disclosure is not limited thereto.

The first processor 210 may control the second processor 240 to obtain motion vector information of an image input to the second processor 240 through the motion estimation model 710, according to allocation of the resources of the second processor 240 to the motion estimation model 710. The second processor 240 may extract motion vector information of the input image through the motion estimation model 710.

The first processor 210 may control the video processor 250 to generate a high frame rate image by performing the motion compensation based on the motion vector information and the input image. The video processor 250 may compensate for a frame in relation to the input image based on the motion vector information through the motion compensation circuit 660.

The image processing unit 220 may generate an output image by using at least one of the second processor 240 or the video processor 250. For example, the output image may be an image which is frame rate-improved, contrast-improved, and color-corrected from an input image.

The image processing apparatus 100 according to an embodiment of the disclosure may increase the execution time of the motion estimation model in relation to an image having a high resolution and a low frame rate to improve the accuracy of the motion amount estimation.

FIG. 8 illustrates an example of an image processing unit which is resource-allocated to a neural network based on information about an input image according to an embodiment of the disclosure.

FIG. 8 illustrates neural networks to which resources of the second processor 240 are allocated when the resolution information of an image input to the image processing apparatus 100 is 4 k, and frame rate information is 60 Hz. In FIG. 8, an area of each neural network block corresponds to an allocation amount of resources of the second processor 240.

For example, the first processor 210 may allocate the resources of the second processor 240 to an upscaling model 810 when the resolution of the input image is 4 k. The upscaling model 810 may include an upscaling model capable of processing image quality of 4 k or higher, for example, a 4 k-to-8 k upscaling model.

For example, the first processor 210 may allocate the resources of the second processor 240 to a motion estimation model 820 when the frame rate is 60 Hz.

For example, the first processor 210 may further allocate the resources of the second processor 240 to a contrast enhancement model 620 to perform a contrast enhancement algorithm with respect to the input image.

For example, the resource amount allocated to the upscaling model 810 may be identical or similar to the resource amount allocated to the motion estimation model 820.

The image processing unit 220 may generate an 8 k resolution image from a 4 k resolution image through the upscaling model 810 implementing the 4 k-to-8 k upscaling algorithm. When the resources of the second processor 240 are allocated to the upscaling model 810, the upscaler 650 implemented in the video processor 250 (e.g., the second upscaler) may not be used.

The image processing unit 220 may generate an output image by using at least one of the second processor 240 or the video processor 250. For example, the output image may be an image which is upscaled, frame rate-improved, contrast-improved, and color-corrected from an input image.

FIGS. 9A, 9B, 9C, and 9D are each a diagram illustrating an operation of performing image processing with respect to an input image by the image processing unit, according to an embodiment of the disclosure.

Referring to FIGS. 9A to 9C, various orders of executing, by an image processing unit (220a, 220b, 220c, and 220d), a plurality of neural networks to which the resources of the second processor 240 are allocated are described.

Referring to FIG. 9A, the image processing unit 220a according to an embodiment of the disclosure may perform the first quality processing with respect to the input image in the order of an upscaling model 910, a contrast enhancement model 920, and a motion estimation model 930. For example, the upscaling model 910 may process the input image to generate a first image having a resolution higher than that of the input image. The first image output from the upscaling model 910 may be input to the contrast enhancement model 920. The contrast enhancement model 920 may image quality-process the input first image to generate a second image which has an improved contrast in comparison with the first image. The second image output from the contrast enhancement model 920 may be input to the motion estimation model 930. The motion estimation model 930 may output motion vector information representing a motion amount of the input second image. Additional information output from the motion estimation model 930, for example, motion vector information may be input to the video processor 250 along with the second image. The second image and the additional information input to the video processor 250 may be image quality-processed through the motion compensation circuit 660 and the color correction circuit 670. The video processor 250 may generate an output image.

Referring to FIG. 9B, the image processing unit 220b according to an embodiment of the disclosure may execute the upscaling model 910 and the motion estimation model 930 independently from each other to perform the first quality processing with respect to the input image and may sequentially execute the upscaling model 910 and the contrast enhancement model 920.

Referring to FIG. 9c, the image processing unit 220c according to an embodiment of the disclosure may perform the first quality processing with respect to the input image in the order of the upscaling model 910, the contrast enhancement model 920, and the FRC model 930. The FRC model 930 may generate a third image with an improved frame rate, compared to the second image by image quality-processing the second image.

The neural network execution order is not limited to those illustrated in FIGS. 9A, 9B, and 9C, and the order of executing the upscaling model 910, the contrast enhancement model 920, and the FRC model 930 may vary.

Referring to FIG. 9D, the image processing unit 220d according to an embodiment of the disclosure may improve the resolution of an input image having a resolution of 2 k or less by using a 2 k-to-4 k upscaling model 911 and a 4 k-to-8 k upscaling model 912. For example, the 2 k-to-4 k upscaling model 911 may process the input image to generate a first image having a resolution higher than that of the input image. The first image output from the 2 k-to-4 k upscaling model 911 may be input to the 4 k-to-8 k upscaling model 912. The 4 k-to-8 k upscaling model 912 may image quality-process the input first image to generate a second image having a greater resolution than the first image. The second image may be image quality-processed through the color correction circuit 670.

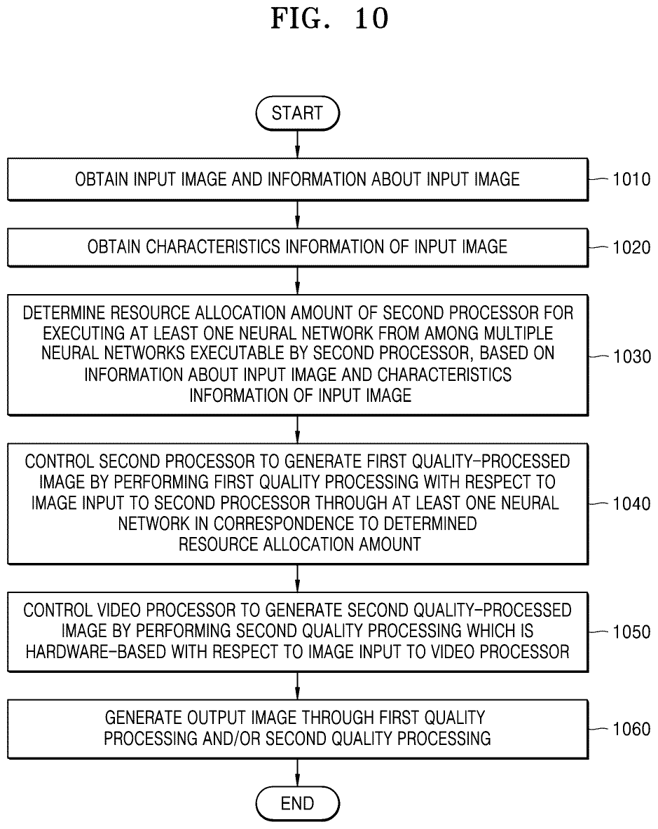

FIG. 10 is a flowchart illustrating an operation of determining, by an image processing apparatus according to an embodiment of the disclosure, a resource allocation amount with respect to a neural network based on characteristic information of an input image.

Referring to FIG. 10, in operation 1010, the image processing apparatus 100 according to an embodiment of the disclosure may obtain the input image and information about the input image. Operation 1010 may correspond to operation 410 of FIG. 4.

In operation 1020, the image processing apparatus 100 according to an embodiment of the disclosure may obtain characteristic information of the input image by analyzing the input image.

In an embodiment of the disclosure, the characteristics information of the input image may include at least one of a motion amount of the input, a quality characteristic of the input image, noise information of the input image, a brightness level of the input image, or a genre of the input image.

For example, the image processing apparatus 100 may perform a characteristic analysis algorithm for analyzing characteristics of the input image. The characteristic analysis algorithm may extract characteristic information by analyzing at least one of a motion amount of the input image, a quality characteristic of the input image, a brightness level of the input image, or a genre of the input image. The characteristic analysis algorithm may be implemented by a characteristic analysis model executed through the second processor 240. Or, the characteristic analysis algorithm may be implemented by a characteristic analysis circuit executed through the video processor 250. For example, the characteristic analysis model may correspond to the image quality analysis model or classification model described in relation to FIG. 3.

For example, the image processing apparatus 100 may obtain brightness information of the input image by making the brightness dispersion of pixels constituting the input image into a histogram.

In operation 1030, the image processing apparatus 100 according to an embodiment of the disclosure may determine the resource allocation amount of the second processor 240 for executing at least one neural network, based on the information about the input image and the characteristic information of the input image.

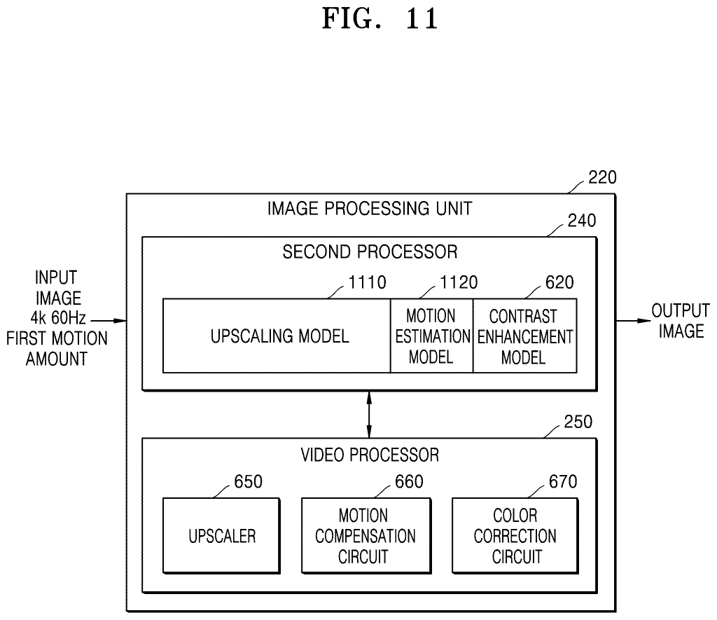

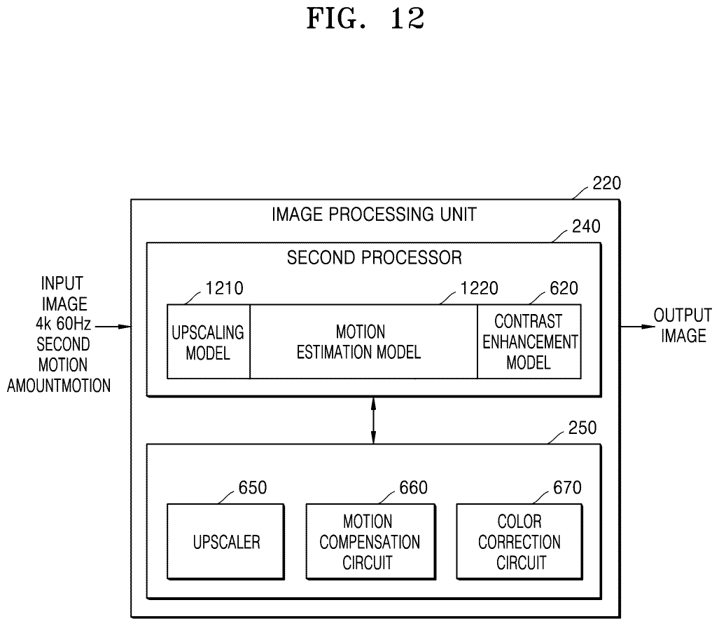

For example, the image processing apparatus 100 may obtain a motion amount of the input image by analyzing the input image. When the input image has a low resolution and a low frame rate, the image processing apparatus 100 may determine a ratio between the resource allocation amount to the upscaling model and the resource allocation amount to the motion estimation amount based on the motion amount of the input image. The foregoing is to be described in detail in relation to FIGS. 11 and 12.

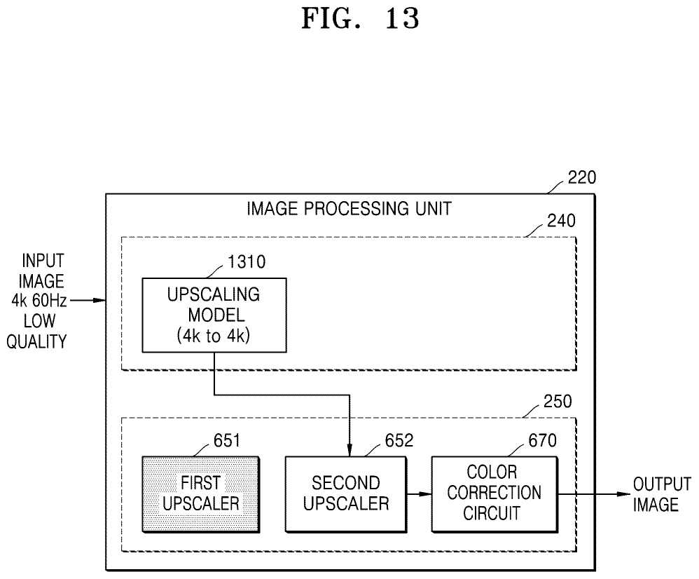

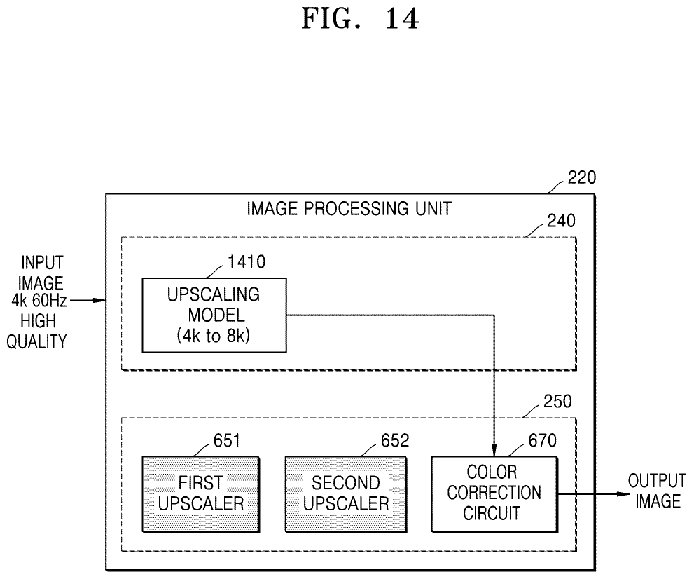

For example, the image processing apparatus 100 may obtain quality information of the input image by analyzing the input image. When the input image has a low resolution and a low frame rate, the image processing apparatus 100 may determine whether to allocate resources to a particular upscaling model based on the quality information of the input image. The upscaling model may vary according to an input resolution and an output resolution. The foregoing is to be described in detail in relation to FIGS. 13 and 14.

For example, the image processing apparatus 100 may obtain noise information of the input image by analyzing the input image. When the input image has great noise, the image processing apparatus 100 may allocate more resources to the noise removal model.

For example, the image processing apparatus 100 may determine the resource allocation amount based on a genre of the input image. For example, when the genre of the input image is sports, the image processing apparatus 100 may allocate more resources to the motion estimation model as the genre requires a large amount of motions.

In operation 1040, the image processing apparatus 100 according to an embodiment of the disclosure may control the second processor 240 to generate the first quality-processed image by performing the first quality processing with respect to the image, input to the second processor 240, through at least one neural network based on the determined resource allocation amount. Operation 1040 may correspond to operation 430 of FIG. 4.

In operation 1050, the image processing apparatus 100 according to an embodiment of the disclosure may control the video processor 250 to generate a second quality-processed image by performing the second image quality-performing in which an image input to the video processor 250 is image-quality processed based on a hardware. Operation 1050 may correspond to operation 440 of FIG. 4.

In operation 1060, the image processing apparatus 100 according to an embodiment of the disclosure may generate an output image through the first quality processing and/or the second quality processing. Operation 1060 may correspond to operation 450 of FIG. 4.

FIG. 11 illustrates an example of an image processing unit which is resource-allocated to a neural network based on a motion amount of an input image according to an embodiment of the disclosure.

FIG. 11 illustrates neural networks to which resources of the second processor 240 are allocated when resolution information of an image input to the image processing apparatus 100 is 4 k, frame rate information is 60 Hz, and the input image has few motions. The resource allocation amount to the contrast enhancement model 620 may correspond to that of FIG. 8.

Referring to FIG. 11, the image processing apparatus 100 may obtain motion amount information of the input image by analyzing the input image. For example, when the input image has a first motion amount or less, the image processing apparatus 100 may determine that the input image has insufficient motions.

Even when the input image is an image having 4 k and 60 Hz as illustrated in FIG. 8, the image processing apparatus 100 may allocate more resources to an upscaling model 1110 to the image if the image has insufficient motions.

When the first processor 210 determines that the input image has insufficient motions, the resources of the second processor 240 may be further allocated to the upscaling model 1110, and the resources of the second processor 240 may be less allocated to a motion estimation model 1120. For example, a ratio between the resource allocation amount to the upscaling model 1110 and the resource allocation amount to the motion estimation model 1120 maybe 6:4; however, the disclosure is not limited thereto.

FIG. 12 illustrates an example of an image processing unit which is resource-allocated to a neural network based on a motion amount of an input image according to an embodiment of the disclosure.

FIG. 12 illustrates neural networks to which resources of the second processor 240 are allocated when resolution information of an image input to the image processing apparatus 100 is 4 k, frame rate information is 60 Hz, and the input image has sufficient motions. The resource allocation amount to the contrast enhancement model 620 may correspond to that of FIG. 8.

Referring to FIG. 12, the image processing apparatus 100 may obtain motion amount information of the input image by analyzing the input image. For example, when the input image has a second motion amount or greater, the image processing apparatus 100 may determine that the input image has sufficient motions.

Even when the input image is an image having 4 k and 60 Hz as illustrated in FIG. 8, the image processing apparatus 100 may allocate more resources to a motion estimation model 1220 to the image if the image has sufficient motions.

When the first processor 210 determines that the input image has sufficient motions, the resources of the second processor 240 may be further allocated to the motion estimation model 1120, and the resources of the second processor 240 may be less allocated to the upscaling model 1110. For example, a ratio between the resource allocation amount to the upscaling model 1110 and the resource allocation amount to the motion estimation model 1120 maybe 4:6; however, the disclosure is not limited thereto.

In an embodiment of the disclosure, when the image has sufficient motions, as a user may not recognize detailed texture difference or sharpness difference, improvement in frame rate may provide maximum image quality performance. Accordingly, the image processing apparatus 100 may allocate more resources to an algorithm that improves a frame rate to effectively provide the image quality performance.

In an embodiment of the disclosure, the image processing apparatus 100 may determine the resource allocation amount based on a genre of the input image. For example, when the genre of the input image is sports, the image processing apparatus 100 may allocate more resources to the motion estimation model 1220 as the genre requires a large amount of motions.

FIG. 13 illustrates an example of an image processing unit which is resource-allocated to a neural network based on quality of an input image according to an embodiment of the disclosure.

FIG. 13 illustrates an upscaling model 1310 to which resources of the second processor 240 are allocated when resolution information of an image input to the image processing apparatus 100 is 4 k, frame rate information is 60 Hz, and the input image is a low-quality image. The resource allocation mount to the motion estimation model and the contrast enhancement model may correspond to that of FIG. 8 and its illustration may be omitted in FIG. 13.

Referring to FIG. 13, the image processing apparatus 100 may obtain quality information of the input image by analyzing the input image. For example, quality of an input image may vary according to a network transmission speed, compression degree, etc. even when the input image has the same resolution and frame rate. For example, the image processing apparatus 100 may determine that the input image is a low-quality image by analyzing a compression deterioration degree of the input image, a blurriness degree, a sharpness, a noise level, a resolution of the image, etc.

When the input image has 4 k and 60 Hz, the image processing apparatus 100 may allocate the resources of the second processor 240 to the upscaling model 1310 having an input resolution and an out resolution that are the same as the resolution of the input image to create textures or perform sharpness enhancement. For example, the upscaling model 1310 may be a 4 k-to-4 k upscaling model. The upscaling model 1310 having the input resolution and the output resolution that are identical to each other may improve the quality of image instead of adjusting the size of the image.

The image processing apparatus 100 may control the second processor 240 to generate a first image having high-quality by inputting the input image to the upscaling model 1310. The first image having high-quality may be input to a second upscaler 652 of the video processor 250. The image processing apparatus 100 may control the video processor 250 to generate an upscaled image by inputting the high-quality first image to the second upscaler 652. The second upscaler 652 may be an upscaling circuit which receives a 4 k image, performs upscaling, and outputs an 8 k image.

The image processing apparatus 100 may perform quality improvement with respect to the input image by using the upscaling model 1310 and perform improvement with respect to the input image by using the second upscaler 652. For example, the upscaling model may require a computation amount that increases proportionally to an output resolution, and the image processing apparatus 100 may use the second upscaler 652 implemented as a hardware for adjusting the size of image to minimize the computation amount.

FIG. 13 illustrates a case in which a first upscaler 651 is implemented in the video processor 250. In this case, as the input image has a 4 k resolution, the first upscaler 651 may not be used. However, the disclosure is not limited thereto, and in some cases, the first upscaler 651 may not be implemented in the video processor 250.

FIG. 14 illustrates an example of an image processing unit which is resource-allocated to a neural network based on quality of an input image according to an embodiment of the disclosure.

FIG. 14 illustrates an upscaling model 1410 to which resources of the second processor 240 are allocated when resolution information of an image input to the image processing apparatus 100 is 4 k, frame rate information is 60 Hz, and the input image is a high-quality image. The resource allocation mount to the motion estimation model and the contrast enhancement model may correspond to that of FIG. 8 and its illustration may be omitted in FIG. 14.

Referring to FIG. 14, the image processing apparatus 100 may obtain quality information of the input image by analyzing the input image. For example, the image processing apparatus 100 may determine that the input image is a high-quality image by analyzing the input image. For example, when the image is received from a Blu-ray disk player or input through a high-performance network, etc., the image processing apparatus 100 may identify that input image as a high-quality image. For example, the high-quality image may include high frequency information of pixel units (for example, sharpness, detail, etc.)

When the input image has 4 k and 60 Hz and is a high-quality image, the image processing apparatus 100 may allocate the resources of the second processor 240 to the upscaling model 1410. The upscaling model 1410 may be an upscaling model having an input resolution corresponding to the resolution of the input image and an output resolution corresponding to a target resolution, for example, a 4 k-to-8 k upscaling model.

The image processing apparatus 100 may control the second processor 240 to generate an upscaled image by inputting the input image to the upscaling model 1410.

As the input image includes high frequency information of 4 k pixel units, there may be no need to obtain additional improvement in pixel by using an upscaling model having an input resolution and an output resolution that are identical to each other (for example, 4 k-to-4 k). Instead, the image processing apparatus 100 may allocate the resources of the second processor 240 to an upscaling model having an output resolution identical to a target resolution (e.g., 8 k), for example, a 4 k-to-8 k upscaling model to generate high frequency information of pixel units at the target resolution. Accordingly, when the upscaling model 1410 is executed, a required computation amount may be greater in comparison with the case in which the second upscaler 652 implemented as a hardware is executed; however, as an output image having higher quality may be generated, and accordingly, maximum quality processing performance may be implemented.

FIG. 14 illustrates a case in which the first upscaler 651 and the second upscaler 652 are implemented in the video processor 250. In this case, as the input image has a 4 k resolution, the first upscaler 651 may not be used. In addition, the input resolution of the second upscaler 652 may correspond to the resolution of the input image; however, the second upscaler 652 may not be used for maximum performance of the image processing apparatus 100.

However, the disclosure is not limited thereto, and in some cases, the first upscaler 651 and the second upscaler 652 may not be implemented in the video processor 250.

FIG. 15 is a flowchart illustrating an operation of performing image processing by an image processing apparatus according to an embodiment of the disclosure based on an activation/inactivation command.

Referring to FIG. 15, in operation 1510, the image processing apparatus 100 according to an embodiment of the disclosure may obtain the input image and information about the input image. Operation 1510 may correspond to operation 410 of FIG. 4.

In operation 1520, the image processing apparatus 100 according to an embodiment of the disclosure may receive an activation/inactivation command regarding the quality processing function.

For example, the image processing apparatus 100 may receive an inactivation command with respect to an operation of a neural network performing image processing corresponding to the image processing function. For example, the image processing function may correspond to the image processing algorithm described above for example, the upscaling algorithm, the FRC algorithm, the contrast enhancement algorithm, etc.

Or, for example, the image processing apparatus 100 may receive an activation command with respect to a subtitle provision function. For example, the subtitle provision function may correspond to an algorithm for generating subtitles by analyzing the input image. The subtitle provision function may be performed by a neural network implemented in the second processor 240; however, the disclosure is not limited thereto.

Or, for example, the image processing apparatus 100 may receive an activation command with respect to a low-power mode.

The activation/inactivation command according to an embodiment of the disclosure may be received through an input interface, for example, a touch screen, a microphone, a keyboard, etc.; however, the disclosure is not limited thereto. For example, the image processing apparatus 100 may receive an activation/inactivation command from a user through the input interface.

In operation 1530, the image processing apparatus 100 according to an embodiment of the disclosure may determine the resource allocation amount of the processor with respect to at least one neural network, based on the information about the input image and the activation/inactivation command.

For example, the image processing apparatus 100 may allocate the resources of the second processor 240 to neural networks other than any one or more neural networks that perform the image processing function, based on the inactivation command regarding the image processing function.

For example, the image processing apparatus 100 may collect all resources allocated to any one neural network performing the image processing function and reallocate the collected resources to other neural networks. In this regard, the operation of collecting resources allocated to any one neural network and reallocating the collected resources to other neural networks may correspond to an operation of turning off a particular program and turning on another program.

For example, the image processing apparatus 100 may reduce a resource allocation amount of the second processor 240 with respect to each of the plurality of neural networks, based on an activation command regarding a low power mode. For example, the image processing apparatus 100 may reallocate resources to use only some of the total resource amount of the second processor 240.

For example, the image processing apparatus 100 may additionally allocate resources of the second processor 240 with respect to a neural network performing the subtitle provision function, based on the activation command regarding the subtitle provision function.

In operation 1540, the image processing apparatus 100 according to an embodiment of the disclosure may control the second processor 240 to generate the first quality-processed image by performing the first quality processing with respect to the image, input to the second processor 240, through at least one neural network based on the determined resource allocation amount. Operation 1540 may correspond to operation 430 of FIG. 4.

In operation 1550, the image processing apparatus 100 according to an embodiment of the disclosure may control the video processor 250 to generate a second quality-processed image by performing the second image quality-performing in which an image input to the video processor 250 is image-quality processed based on a hardware. Operation 1550 may correspond to operation 440 of FIG. 4.

In operation 1560, the image processing apparatus 100 according to an embodiment of the disclosure may generate an output image through the first quality processing and/or the second quality processing. Operation 1560 may correspond to operation 450 of FIG. 4.

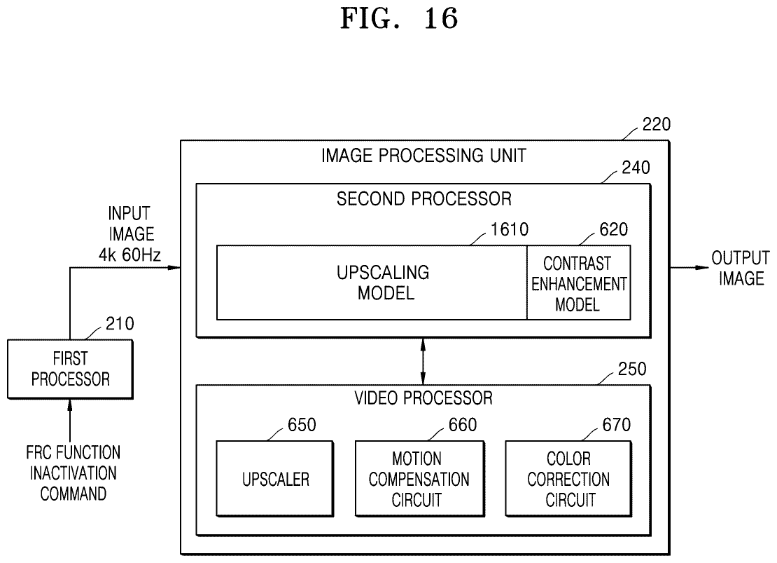

FIG. 16 illustrates an example of an image processing unit which is resource-allocated to a neural network based on an inactivation command, according to an embodiment of the disclosure.

FIG. 16 illustrates neural networks to which resources of the second processor 240 are allocated when resolution information of an image input to the image processing apparatus 100 is 4 k, frame rate information is 60 Hz, and the image processing apparatus 100 receives an FRC function inactivation command. The resource allocation amount to the contrast enhancement model 620 may correspond to that of FIG. 8.

Referring to FIG. 16, the first processor 210 may receive an inactivation command regarding the FRC function. The first processor 210 may collect resource allocation with respect to the motion estimation model and reallocate the collected resources to another neural network, for example, an upscaling model 1610, based on the inactivation command.

The image processing apparatus 100 may use remaining resources of the second processor 240 to the maximum according to the inactivation command and quickly perform computation regarding another quality processing neural network.

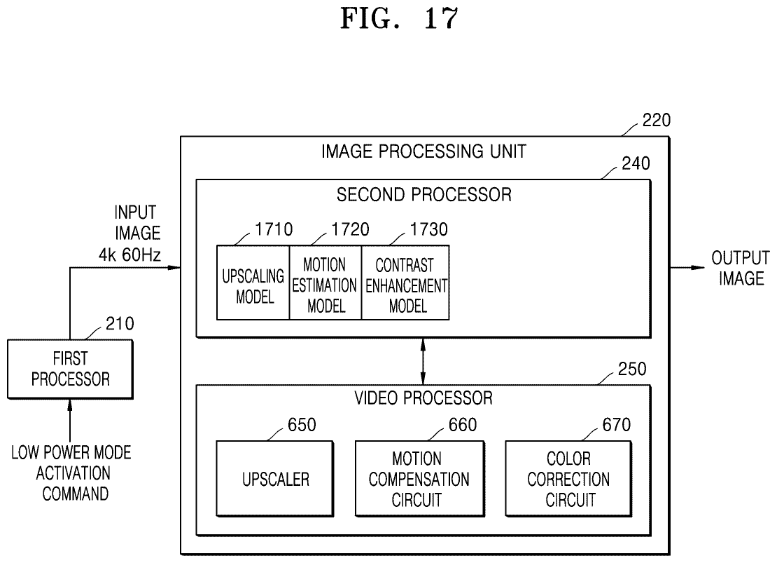

FIG. 17 illustrates an example of an image processing unit which is resource-allocated to a neural network based on an activation command regarding the low-power mode, according to an embodiment of the disclosure.

FIG. 17 illustrates neural networks to which resources of the second processor 240 are allocated when resolution information of an image input to the image processing apparatus 100 is 4 k, frame rate information is 60 Hz, and the image processing apparatus 100 receives a low-power mode activation command. A ratio among resource allocation amounts to an upscaling model 1710, a motion estimation model 1720, and a contrast enhancement model 1730 may correspond to that of FIG. 8.

Referring to FIG. 17, the first processor 210 may receive an activation command regarding the low-power mode. The activation model regarding the low-power mode may be received through the input interface or may be set in a system.

The first processor 210 may change resource allocation amounts to the upscaling model 1710, the motion estimation model 1720, and the contrast enhancement model 1730 based on an activation command. For example, the resource allocation amounts to the upscaling model 1710, the motion estimation model 1720, and the contrast enhancement model 1730 may be each reduced while maintaining the ration among the resource allocation amounts to the upscaling model 1710, the motion estimation model 1720, and the contrast enhancement model 1730. The first processor 210 may collect some of the resources, for example, 50% from the upscaling model 1710, the motion estimation model 1720, and the contrast enhancement model 1730.

The image processing apparatus 100 may use minimum remaining resources of the second processor 240 according to the low-power mode activation command to increase power consumption efficiency.

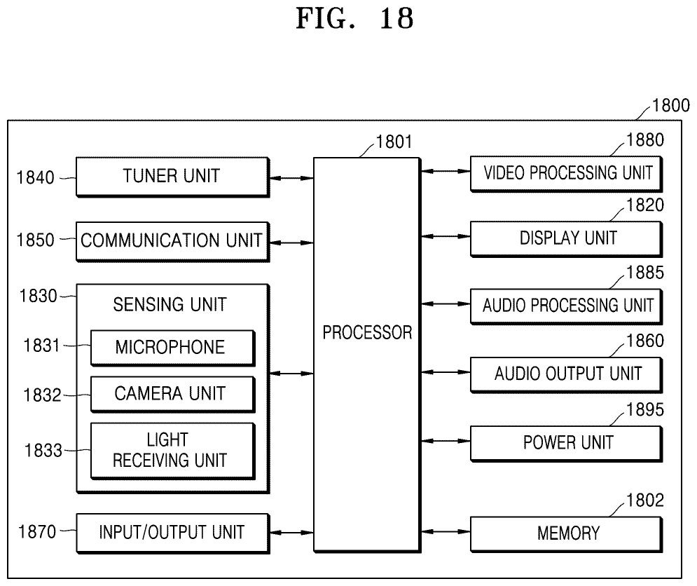

FIG. 18 is a detailed block diagram of an image processing apparatus according to an embodiment of the disclosure.

Referring to FIG. 18, an image processing apparatus 1800 may include a tuner unit 1840, a processor 1801, a display 1820, a communication unit 1850, a sensing unit 1830, an input/output unit 1870, a video processing unit 1880, an audio processing unit 1885, an audio output unit 1860, memory 1802, and a power unit 1895.

The tuner unit 1840 according to an embodiment of the disclosure may tune and select a frequency of a channel desired to be received by the image processing apparatus 1800 from among numerous radio signal components through amplification, mixing, resonance, etc. of a broadcast signal received in a wired or wireless manner. The broadcast signal may include audio, video, and addition information (e.g., electronic program guide (EPC).

The tuner unit 1840 may receive the broad cast signal from various sources, such as terrestrial broadcasting, cable broadcasting, satellite broadcasting, internet broadcasting, etc. The tuner unit 1840 may receive the broadcast signal from a source such as analog broadcasting or digital broadcasting.

The communication unit 1850 may receive and transmit data or signals from and to an external device or a server. For example, the communication unit 1850 may include a Wi-Fi model, a Bluetooth module, an infrared communication module, a wireless communication module, a LAN module, an Ethernet module, a wired communication module, etc. Each communication module may be implemented in the form of at least one hardware chip.

The Wi-Fi module and the Bluetooth module may perform communication by using the Wi-Fi method and the Bluetooth method, respectively. When the Wi-Fi module or the Bluetooth module is used, various connection information such as SSID and session key may be first received and transmitted, and by using those, communication connection may be conducted to receive and transmit various information. The wireless communication module may include at least one communication chip performing communication according to various wireless communication standards, such as Zigbee, 3rd generation (3G), 3rd generation partnership project (3GPP), long term evolution (LTE), LTE advanced (LTE-A), 4th generation (4G), 5th generation (5G), etc.

The sensing unit 1830 according to an embodiment of the disclosure may sense a voice of a user, an image of a user, or an interaction of a user, and may include a microphone 1831, a camera unit 1832, and a light receiving unit 1833.

The microphone 1831 may receive a voice uttered by a user. The microphone 1831 may convert the receive voice into an electrical signal and output the electrical signal to the processor 1801.

The light receiving unit 1833 may receive an optical signal (including a control signal) received from an external control device through a light window (not shown) of a bezel of the display 1820. The light receiving unit 1833 may receive an optical signal corresponding to a user input (e.g., a touch, a touch gesture, a voice, or a motion) from the control device. A control signal may be extracted from the received optical signal by the control by the processor 1801.

The input/output unit 1870 according to an embodiment of the disclosure may receive a video (e.g., a video clip, etc.), an audio (e.g., a voice, music, etc.), and additional information (e.g., EPG, etc.) from the outside of the image processing apparatus 1800. The input/out unit 1870 may include at least one of a high-definition multimedia interface (HDMI), a mobile high-definition link (MHL), an universal serial bus (USB), a display port (DP), a thunderbolt, a video graphics array (VGA) port, an RGB port, a D-subminiature (D-SUB), a digital visual interface (DVI), a component jack, or a PC port.

The video processing unit 1880 according to an embodiment of the disclosure may perform processing with respect to video data received by the image processing apparatus 1800. The video processing unit 1880 may perform various image processing with respect to the video data, such as decoding, scaling, noise filtering, frame rate conversion, resolution conversion, etc. The video processing unit 1880 may correspond to the image processing unit 220 of FIG. 2.

In addition, the processor 1801 may include at least one of a central processing unit (CPU), a graphic processing unit (GPU), or a video processing unit (VPU). Or, according to an embodiment of the disclosure, a system-on-chip (SoC) integrating at least one of a CPU, a GPU, or a VPU may be implemented. Or, the processor 1801 may further include a neural processing unit (NPU). Or, the processor 1801 may further include an ASIC.

The processor 1801 according to an embodiment of the disclosure may include at least one of the first processor 210 or the second processor 240. In an embodiment of the disclosure, the first processor 210 and the second processor 240 may be implemented as a single integrated chip.

The memory 1802 according to an embodiment of the disclosure may store data, a program, or an application for driving and controlling the image processing apparatus 1800.

In addition, the program stored in the memory 1802 may include one or more instructions. The program (e.g., one or more instructions) or the application stored in the memory 1802 may be executed by the processor 1801.

The processor 1801 according to an embodiment of the disclosure may execute the one or more instructions stored in the memory 1802 to obtain the input image. The input image may be an image prestored in the memory 1802 or an image received from an external device through the tuner unit 1840 or the communication unit 1850. Or, the input image may be an image on which various image processing such as decoding, scaling, noise filtering, frame rate conversion, resolution conversion, etc. is performed in the video processing unit 1880.

The display 1820 according to an embodiment of the disclosure may convert a control signal, an on-screen display (OSD) signal, a data signal, an image signal processed by the processor 1801 to generate a driving signal. The display 1820 may be implemented as a plasma display panel (PDP), a liquid crystal display (LCD), an organic light-emitting diode (OLED), a flexible display, etc. and may be implemented as a three-dimensional (3D) display. Moreover, the display 1820 may be used as an input device in addition to an output device including a touch screen.

The audio processing unit 1885 may perform processing of audio data. The audio processing unit 1885 may perform various processing such as decoding, amplification, noise filtering, etc. in relation to the audio data. The audio processing unit 1885 may include a plurality of audio processing modules for processing audio corresponding to a plurality of contents.

The audio output unit 1860 may output an audio included in a broadcast signal received through the tuner unit 1840 by the control by the processor 1801. The audio output unit 1860 may output an audio input through the communication unit 1850 or the input/output unit 1870 (e.g., a voice, a sound, etc.) In addition, the audio output unit 1860 may output an audio stored in the memory 1802 according to the control by the processor 1801. The audio output unit 1860 may include at least one of a speaker, a headphone output terminal, or a Sony/Philips digital interface (S/PDIF).

The power unit 1895 may supply power input from a power source from the outside to components in the image processing apparatus 1800 according to the control by the processor 1801. Moreover, the power unit 1895 may supply power output from one or more batteries (not shown) in the image processing apparatus 1800 to inner components according to the control by the processor 1801.

The memory 1802 may store various data, a program, and/or an application for driving and controlling the image processing apparatus 1800 according to the control by the processor 1801.

The processor 1801 according to an embodiment of the disclosure may obtain an input image and information about the input image. The processor 1801 according to an embodiment of the disclosure may determine a resource allocation amount of the processor 1801 for executing at least one neural network from among the plurality of neural networks, based on the information about the input image. The processor 1801 according to an embodiment of the disclosure may perform the first quality processing with respect to the input through at least one neural network in correspondence to the determined resource allocation amount to generate the first quality-processed image. The processor 1801 according to an embodiment of the disclosure may perform the second quality processing, which is hardware-based, with respect to the image to generate the second quality-processed image. The processor 1801 according to an embodiment of the disclosure may generate an output image through the first quality processing and/or the second quality processing.

The first processor 210 according to an embodiment of the disclosure may be configured to execute the at least one instruction to obtain an input image and information about the input image.

The first processor 210 according to an embodiment of the disclosure may determine a resource allocation amount of the second processor 240 for performing at least one neural network from among a plurality of neural networks executable by the second processor 240, based on the information about the input image.

The first processor 210 according to an embodiment of the disclosure may control the second processor 240 to generate a first quality-processed image by performing first quality processing with respect to an image, input to the second processor 240, through at least one neural network based on the determined resource allocation amount.

The first processor 210 according to an embodiment of the disclosure may control the video processor 250 to generate a second quality-processed image by performing second quality processing which is hardware-based, with respect to an image input to the video processor 250.

The first processor 210 according to an embodiment of the disclosure may generate an output image through at least one of the first quality processing or the second quality processing.

The first processor 210 according to an embodiment of the disclosure may be configured to execute the at least one instruction to determine, based on first information of the input image, a resource allocation amount of the second processor 240 with respect to a first neural network configured to perform quality processing regarding the first information from among the plurality of neural networks.

The first processor 210 according to an embodiment of the disclosure may determine, based on second information of the input image, a resource allocation amount of the second processor 240 with respect to a second neural network configured to perform quality processing regarding the second information from among the plurality of neural networks.

A ratio between the resource allocation with respect to the first neural network and the resource allocation with respect to the second neural network may be determined according to a value representing the first information about the input image and a value representing the second information about the input image.

The first information may include resolution information, and the second information may include frame rate information.

The first processor 210 according to an embodiment of the disclosure may be configured to execute the at least one instruction to determine the resource allocation amount with respect to the first neural network 610 to be greater than the resource allocation amount with respect to the second neural network when the input image has a low resolution and a high frame rate.

The first processor 210 according to an embodiment of the disclosure may be configured to execute the at least one instruction to determine the resource allocation amount with respect to the first neural network to be less than the resource allocation amount with respect to the second neural network 710 when the input image has a high resolution and a low frame rate.

The first processor 210 according to an embodiment of the disclosure may be configured to execute the at least one instruction to determine the resource allocation amount with respect to the first neural network 810 to correspond to the resource allocation amount with respect to the second neural network 820 when the input image has a low resolution and a low frame rate.

The first processor 210 according to an embodiment of the disclosure may be configured to execute the at least one instruction to determine whether to allocate resources of the second processor 240 with respect to an upscaling model 610, based on at least one of a resolution of the input image, presence of an upscaler 650 included in the video processor 250, or a remaining computation amount of the second processor 240.

The first processor 210 according to an embodiment of the disclosure may be configured to execute the at least one instruction to control the second processor 240 to generate an upscaled image corresponding to the first quality-processed image by upscaling an image, input to the second processor 240, through the upscaling model 610, according to allocation of resources of the second processor 240 to the upscaling model 610.

The first processor 210 according to an embodiment of the disclosure may be configured to execute the at least one instruction to control the video processor 250 to generate an upscaled image corresponding to the second quality-processed image, by upscaling an image input to the video processor 250, according to implementation of the upscaler 650 in the video processor 250.

The first processor 210 according to an embodiment of the disclosure may be configured to execute the at least one instruction to determine a resource allocation amount of the second processor 240 with respect to a motion estimation model 930 from among the plurality of neural networks when the input image has a low frame rate.

The first processor 210 according to an embodiment of the disclosure may be configured to execute the at least one instruction to control the second processor 240 to obtain motion vector information of the image input to the second processor 240 through the motion estimation model 930, according to allocation of resources of the second processor 240 to the motion estimation model 930.

The first processor 210 according to an embodiment of the disclosure may be configured to execute the at least one instruction to control the video processor 250 to generate a high frame rate image corresponding to the second quality-processed image through motion compensation processing based on the motion vector information and the input image.

The second processor 240 may be configured to perform the first quality processing with respect to the input image through a plurality of operators.

The video processor 250 may be configured to perform the second quality processing with respect to the input image through a single operator per each image processing circuit.

The video processor 250 may include at least one of an upscaler, a dispersion correction circuit, a color difference correction circuit, a high quality processing circuit, or a motion compensation circuit.

The first processor 210 according to an embodiment of the disclosure may be configured to execute the at least one instruction to obtain characteristics information of the input image by analyzing the input image.

The first processor 210 according to an embodiment of the disclosure may be configured to execute the at least one instruction to determine a resource allocation amount of the second processor 240 with respect to the at least one neural network based on the characteristics information of the input image.

The characteristics information of the input image may include at least one of a motion amount of the input, a quality characteristic of the input image, noise information of the input image, a brightness level of the input image, or a genre of the input image.

The first processor 210 according to an embodiment of the disclosure may be configured to execute the at least one instruction to obtain the motion amount of the input image.

The first processor 210 according to an embodiment of the disclosure may be configured to execute the at least one instruction to allocate more resources of the second processor 240 to the first neural network when the input image has a small motion amount. The first processor 210 according to an embodiment of the disclosure may be configured to execute the at least one instruction to allocate more resources of the second processor 240 to the second neural network when the input image has a great motion amount.

The first processor 210 according to an embodiment of the disclosure may be configured to execute the at least one instruction to obtain the quality characteristic of the input image.

The first processor 210 according to an embodiment of the disclosure may be configured to execute the at least one instruction to allocate resources of the second processor 240 to a first upscaling model having an input resolution and an output resolution which correspond to the resolution of the input image when the input image has low quality. The first processor 210 according to an embodiment of the disclosure may allocate resources of the second processor 240 to a second upscaling model having an input resolution corresponding to the resolution of the input image and an output resolution corresponding to a target resolution when the input image has high quality.

The first processor 210 according to an embodiment of the disclosure may be configured to execute the at least one instruction to receive an inactivation command regarding an image processing function.

The first processor 210 according to an embodiment of the disclosure may be configured to execute the at least one instruction to allocate resources of the second processor 240 to neural networks other than any one or more neural networks which perform the image processing function, based on the inactivation command.

The first processor 210 according to an embodiment of the disclosure may be configured to execute the at least one instruction to receive an activation command regarding a low power mode.

The first processor 210 according to an embodiment of the disclosure may be configured to execute the at least one instruction to reduce a resource allocation amount of the second processor 240 with respect to each of the plurality of neural networks based on the activation command.

The operation method of the image processing apparatus 100 according to an embodiment of the disclosure includes obtaining an input image and information about the input image, determining, based on the information about the input image, a resource allocation amount of the second processor 240 to execute at least one neural network from among a plurality of neural networks executable by the second processor 240, controlling the second processor 240 to generate a first quality-processed image by performing first quality processing with respect to an image input to the second processor 240 through the at least one neural network based on the determined resource allocation amount, controlling the video processor 250 to generate a second quality-processed image by performing second quality processing which is hardware-based, with respect to an image input to the video processor 250, and generating an output image through the first quality processing and/or the second quality processing.

The determining of the resource allocation amount of the second processor 240 may include determining, based on first information of the input image, a resource allocation amount of the second processor 240 with respect to a first neural network configured to perform quality processing regarding the first information from among the plurality of neural networks, and determining, based on second information of the input image, a resource allocation amount of the second processor 240 with respect to a second neural network configured to perform quality processing regarding the second information from among the plurality of neural networks. A ratio between the resource allocation with respect to the first neural network and the resource allocation with respect to the second neural network may be determined according to a value representing the first information about the input image and a value representing the second information about the input image.

The first information may include resolution information, and the second information may include frame rate information.

The determining of the resource allocation amount of the second processor 240 may include determining the resource allocation amount with respect to the first neural network to be greater than the resource allocation amount with respect to the second neural network when the input image has a low resolution and a high frame rate, determining the resource allocation amount with respect to the first neural network to be less than the resource allocation amount with respect to the second neural network when the input image has a high resolution and a low frame rate, and determining the resource allocation amount with respect to the first neural network to correspond to the resource allocation amount with respect to the second neural network when the input image has a low resolution and a low frame rate.

The operation method may further include determining a resource allocation amount of the second processor 240 with respect to a motion estimation model from among the plurality of neural networks when the input image has a low frame rate, controlling the second processor 240 to obtain motion vector information of the image input to the second processor 240 through the motion estimation model, according to allocation of resources of the second processor 240 to the motion estimation model; and controlling the video processor 250 to generate a high frame rate image corresponding to the second quality-processed image through motion compensation processing based on the motion vector information and the input image.

The operation method may further include obtaining characteristics information of the input image by analyzing the input image (1020 in FIG. 10) and determining a resource allocation amount of the second processor 240 with respect to the at least one neural network based on the characteristics information of the input image (1030 in FIG. 10). The characteristics information of the input image may include at least one of a motion amount of the input, a quality characteristic of the input image, noise information of the input image, a brightness level of the input image, or a genre of the input image.

The obtaining of the characteristics information of the input image may include obtaining the motion amount of the input image. The determining of the resource allocation amount of the second processor 240 may include allocating more resources of the second processor 240 to the first neural network when the input image has a small motion amount and allocating more resources of the second processor 240 to the second neural network when the input image has a great motion amount.

The obtaining of the characteristics information of the input image may include obtaining the quality characteristic of the input image. The determining of the resource allocation amount of the second processor 240 may include allocating resources of the second processor 240 to a first upscaling model having an input resolution and an output resolution which correspond to the resolution of the input image when the input image has low quality and allocating resources of the second processor 240 to a second upscaling model having an input resolution corresponding to the resolution of the input image and an output resolution corresponding to a target resolution when the input image has high quality.

According to an embodiment of the disclosure, provided is a computer-readable recording medium having recorded thereon a program for performing at least one of the operation methods of the image processing apparatus described above.

A non-transitory storage medium may be provided as a machine-readable storage medium. The non-transitory storage medium simply means that the medium is tangible and does not include signals (e.g., electromagnetic waves), and this term is not intended to distinguish semi-permanent storage of data in a storage medium from temporary storage of the same. For example, the non-transitory storage may include a buffer in which data is temporarily stored.

According to an embodiment of the disclosure, the method described in an embodiment of the disclosure may be included and provided in a computer program product. A computer program product may be traded between a seller and a buyer. The computer program may be distributed in the form of a machine-readable storage medium (e.g., compact disc read-only memory; CD-ROM), or distributed (e.g., downloaded or uploaded) online through an application store or directly between two user devices (e.g., smartphones). In the case of online distribution, at least some of the computer program products (e.g., a downloadable application, etc.) may be at least temporarily stored in a storage medium readable by devices, such as a memory of a manufacturer server, an application store server, or a relay server or temporarily generated.

At least one of the components, elements, modules or units (collectively “components” in this paragraph) represented by a block in the drawings, may be embodied as various numbers of hardware, software and/or firmware structures that execute respective functions described above, according to an example embodiment. For example, at least one of these components may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU) that performs the respective functions, a microprocessor, or the like. Two or more of these components may be combined into one single component which performs all operations or functions of the combined two or more components. Also, at least part of functions of at least one of these components may be performed by another of these components. Further, although a bus is not illustrated in the above block diagrams, communication between the components may be performed through the bus. Functional aspects of the above example embodiments may be implemented in algorithms that execute on one or more processors. Furthermore, the components represented by a block or processing steps may employ any number of related art techniques for electronics configuration, signal processing and/or control, data processing and the like.

Although example embodiments of the disclosure have been described with reference to the accompanying drawings, those of ordinary skill in the art to which the disclosure pertains will understand that the disclosure may be embodied in other specific forms without changing the technical spirit or essential features thereof. Therefore, it should be understood that the example embodiments described above are illustrative in all aspects and not restrictive.

What is claimed is:

1. An image processing apparatus comprising:
memory configured to store at least one instruction;
a first processor configured to execute the at least one instruction stored in the memory;
a second processor; and
a video processor,
wherein the at least one instruction, when executed by the first processor individually or collectively, causes the image processing apparatus to:
obtain an input image and information about the input image;
determine, based on the information about the input image, a resource allocation amount of the second processor to execute at least one neural network from among a plurality of neural networks executable by the second processor;
control the second processor to generate a first quality-processed image by performing first quality processing with respect to an image, input to the second processor, through the at least one neural network based on the determined resource allocation amount;
control the video processor to generate a second quality-processed image by performing second quality processing which is hardware-based, with respect to an image input to the video processor; and
generate an output image through at least one of the first quality processing or the second quality processing.

2. The image processing apparatus of claim 1, wherein the at least one instruction, when executed by the first processor individually or collectively, causes the image processing apparatus to:
determine, based on first information of the input image, a resource allocation amount of the second processor with respect to a first neural network, which is configured to perform quality processing regarding the first information from among the plurality of neural networks; and
determine, based on second information of the input image, a resource allocation amount of the second processor with respect to a second neural network, which is configured to perform quality processing regarding the second information from among the plurality of neural networks, and
wherein a ratio between the resource allocation amount with respect to the first neural network and the resource allocation amount with respect to the second neural network is determined according to a value representing the first information of the input image and a value representing the second information of the input image.

3. The image processing apparatus of claim 2, wherein the first information includes resolution information, and the second information includes frame rate information, and
wherein the at least one instruction, when executed by the first processor individually or collectively, causes the image processing apparatus to:
determine, based on the input image having a low resolution and a high frame rate, the resource allocation amount with respect to the first neural network to be greater than the resource allocation amount with respect to the second neural network;
determine, based on the input image having a high resolution and a low frame rate, the resource allocation amount with respect to the first neural network to be less than the resource allocation amount with respect to the second neural network; and
determine, based on the input image having a low resolution and a low frame rate, the resource allocation amount with respect to the first neural network to correspond to the resource allocation amount with respect to the second neural network.

4. The image processing apparatus of claim 1, wherein the at least one instruction, when executed by the first processor individually or collectively, causes the image processing apparatus to:
determine whether to allocate a resource of the second processor with respect to an upscaling model, based on at least one of a resolution of the input image, whether the video processor comprises an upscaler, or a remaining computation amount of the second processor;
control the second processor to generate an upscaled image corresponding to the first quality-processed image by upscaling the image input to the second processor through the upscaling model, according to allocation of the resource of the second processor to the upscaling model; and
control the video processor to generate an upscaled image corresponding to the second quality-processed image, by upscaling the image input to the video processor, according to the video processor comprising the upscaler.

5. The image processing apparatus of claim 1, wherein the at least one instruction, when executed by the first processor individually or collectively, causes the image processing apparatus to:
determine, based on the input image having a low frame rate, a resource allocation amount of the second processor with respect to a motion estimation model from among the plurality of neural networks;
control the second processor to obtain motion vector information of the image input to the second processor through the motion estimation model, based on the resource allocation amount of the second processor with respect to the motion estimation model; and
control the video processor to generate a high frame rate image corresponding to the second quality-processed image through motion compensation processing based on the motion vector information and the input image.

6. The image processing apparatus of claim 1, wherein the second processor is configured to perform the first quality processing with respect to the input image through a plurality of operators, and
wherein the video processor is configured to perform the second quality processing with respect to the input image through a single operator per each image processing circuit.

7. The image processing apparatus of claim 1, wherein the video processor includes at least one of an upscaler, a dispersion correction circuit, a color difference correction circuit, a high quality processing circuit, or a motion compensation circuit.

8. The image processing apparatus of claim 1, wherein the at least one instruction, when executed by the first processor individually or collectively, causes the image processing apparatus to:
obtain characteristics information of the input image by analyzing the input image; and
determine a resource allocation amount of the second processor with respect to the at least one neural network based on the characteristics information of the input image, and
wherein the characteristics information of the input image includes at least one of a motion amount of the input image, a quality characteristic of the input image, noise information of the input image, a brightness level of the input image, or a genre of the input image.

9. The image processing apparatus of claim 8, wherein the at least one instruction, when executed by the first processor individually or collectively, causes the image processing apparatus to:
obtain the motion amount of the input image; and
allocate a greater resource of the second processor to a first neural network based on the input image having a relatively small amount of motion, and allocate a greater resource of the second processor to a second neural network based on the input image having a relatively great amount of motion.

10. The image processing apparatus of claim 8, wherein the at least one instruction, when executed by the first processor individually or collectively, causes the image processing apparatus to:
obtain the quality characteristic of the input image; and
allocate, based on the input image having low quality, a resource of the second processor to a first upscaling model having an input resolution and an output resolution which correspond to a resolution of the input image, and allocate, based on the input image having high quality, a resource of the second processor to a second upscaling model having an input resolution corresponding to the resolution of the input image and an output resolution corresponding to a target resolution.

11. The image processing apparatus of claim 1, wherein the at least one instruction, when executed by the first processor individually or collectively, causes the image processing apparatus to:
receive an inactivation command regarding an image processing function; and
allocate, based on the inactivation command, a resource of the second processor to neural networks other than any of one or more neural networks which perform the image processing function.

12. The image processing apparatus of claim 1, wherein the at least one instruction, when executed by the first processor individually or collectively, causes the image processing apparatus to:
receive an activation command regarding a low power mode; and
reduce, based on the activation command, a resource allocation amount of the second processor with respect to each of the plurality of neural networks.

13. An operating method of an image processing apparatus, the operating method comprising:
obtaining an input image and information about the input image;
determining, based on the information about the input image, a resource allocation amount of a second processor to execute at least one neural network from among a plurality of neural networks executable by the second processor;
controlling the second processor to generate a first quality-processed image by performing first quality processing with respect to an image, input to the second processor, through the at least one neural network based on the determined resource allocation amount;
controlling a video processor to generate a second quality-processed image by performing second quality processing which is hardware-based, with respect to an image input to the video processor; and
generating an output image through at least one of the first quality processing or the second quality processing.

14. The operating method of claim 13, wherein the determining the resource allocation amount of the second processor comprises:
determining, based on first information of the input image, a resource allocation amount of the second processor with respect to a first neural network configured to perform quality processing regarding the first information from among the plurality of neural networks; and
determining, based on second information of the input image, a resource allocation amount of the second processor with respect to a second neural network configured to perform quality processing regarding the second information from among the plurality of neural networks, and
wherein a ratio between the resource allocation amount with respect to the first neural network and the resource allocation amount with respect to the second neural network is determined according to a value representing the first information of the input image and a value representing the second information of the input image.

15. The operating method of claim 14, wherein the first information includes resolution information, and the second information includes frame rate information, and
wherein the determining the resource allocation amount of the second processor comprises:
determining, based on the input image having a low resolution and a high frame rate, the resource allocation amount with respect to the first neural network to be greater than the resource allocation amount with respect to the second neural network;
determining, based on the input image having a high resolution and a low frame rate, the resource allocation amount with respect to the first neural network to be less than the resource allocation amount with respect to the second neural network; and
determining, based on the input image having a low resolution and a low frame rate, the resource allocation amount with respect to the first neural network to correspond to the resource allocation amount with respect to the second neural network.

16. The operating method of claim 13, further comprising:
determining, based on the input image having a low frame rate, a resource allocation amount of the second processor with respect to a motion estimation model from among the plurality of neural networks;
controlling the second processor to obtain motion vector information of the image input to the second processor through the motion estimation model, based on the resource allocation amount of the second processor with respect to the motion estimation model; and
controlling the video processor to generate a high frame rate image corresponding to the second quality-processed image through motion compensation processing based on the motion vector information and the input image.

17. The operating method of claim 13, further comprising:
obtaining characteristics information of the input image by analyzing the input image; and
determining a resource allocation amount of the second processor with respect to the at least one neural network based on the characteristics information of the input image, and
wherein the characteristics information of the input image includes at least one of a motion amount of the input image, a quality characteristic of the input image, noise information of the input image, a brightness level of the input image, or a genre of the input image.

18. The operating method of claim 17, wherein the obtaining the characteristics information of the input image comprises obtaining the motion amount of the input image, and
wherein the determining of the resource allocation amount of the second processor comprises allocating a greater resource of the second processor to a first neural network based on the input image having a relatively small motion amount, and allocating a greater resource of the second processor to a second neural network based on the input image having a relatively great motion amount.

19. The operating method of claim 17, wherein the obtaining the characteristics information of the input image comprises obtaining the quality characteristic of the input image, and
wherein the determining the resource allocation amount of the second processor comprises allocating a resource of the second processor to a first upscaling model having an input resolution and an output resolution which correspond to a resolution of the input image based on the input image having low quality, and allocating a resource of the second processor to a second upscaling model having an input resolution corresponding to the resolution of the input image and an output resolution corresponding to a target resolution based on the input image having high quality.

20. A non-transitory computer-readable recording medium having recorded thereon a program for performing:
obtaining an input image and information about the input image;
determining, based on the information about the input image, a resource allocation amount of a second processor to execute at least one neural network from among a plurality of neural networks executable by the second processor;
controlling the second processor to generate a first quality-processed image by performing first quality processing with respect to an image, input to the second processor, through the at least one neural network based on the determined resource allocation amount;
controlling the video processor to generate a second quality-processed image by performing second quality processing which is hardware-based, with respect to an image input to the video processor; and
generating an output image through at least one of the first quality processing or the second quality processing.
